(19) United States
(12) Patent Application Publication
(10) Pub. No.: US 2012/0294358 A1
(43) Pub. Date: Nov. 22, 2012

(54) IMAGE PROCESSING DEVICE AND METHOD

(75) Inventors: Teruhiko Suzuki, Tokyo (JP); Peng Wang, Shanghai (CN)

(73) Assignee: Sony Corporation, Tokyo (JP)

(21) Appl. No.: 13/522,613

(22) PCT Filed: Jan. 27, 2011
(86) PCT No.: PCT/JP11/51542

§ 371 Date: Jul. 17, 2012

(30) Foreign Application Priority Data
Feb. 5, 2010 (JP) 2010-024894

(51) Int. Cl. H04N 7/32

(52) U.S. Cl. 375/240.12; 375/E07.125

(57) ABSTRACT

An image processing device and method, enabling improvement in encoding efficiency. A plane approximation unit uses each of pixels values themselves of a block to be processed to obtain each of the parameters of a function representing a plane approximating the pixel values. A plane generating unit obtains pixel values on a plane represented by the supplied plane parameters. A prediction encoding unit predicts the values of the plane parameters, and obtains the difference between the prediction values and the actual plane parameter values, thereby reducing the data amount thereof. The entropy encoding unit further performs entropy encoding of the encoded plane parameters. The encoded plane parameters are supplied to the decoding side.

### TECHNICAL FIELD

The present invention relates to an image processing device and method, and specifically relates to an image processing device and method which enable encoding efficiency to be improved.

### BACKGROUND ART

In recent years, devices handling image information as digital signals, conforming to formats such as MPEG (Moving Picture Experts Group) or the like in which compression thereof by orthogonal transform such as discrete cosine transform or the like and motion compensation, is performed taking advantage of redundancy peculiar to the image information, with transmission and storage of high effective information as an object at that time, have come into widespread use in both information distribution at broadcasting stations and the like, and information reception common homes.

In particular, MPEG2 (ISO (International Organization for Standardization)/IEC (International Electrotechnical Commission) 13818-2) is defined as a general-purpose image encoding format, and is a standard encompassing both of interlaced scanning images and sequential-scanning images, and standard resolution images and high definition images. For example, MPEG2 has widely been employed now by broad range of applications for professional usage and for consumer usage. By employing the MPEG2 compression format, a code amount (bit rate) of 4 through 8 Mbps is allocated in the event of an interlaced scanning image of standard resolution having 720×480 pixels, for example, 18 through 22 Mbps is allocated in the event of an interlaced scanning image of high resolution having 1920×1088 pixels, for example, whereby a high compression rate and excellent image quality can be realized.

With MPEG2, high image quality encoding adapted to broadcasting usage is principally taken as a object, but a lower code amount (bit rate) than the code amount of MPEG1, i.e., an encoding format having a higher compression rate is not handled. According to the spread of portable terminal, it has been expected that needs for such an encoding format will increase from now on, and in response to this, standardization of the MPEG4 encoding format has been performed. With regard to an image encoding format, the specification thereof was confirmed as international standard as ISO/IEC 14496-2 in December in 1998.

Further, in recent years, standardization of a standard called H.26L (ITU-T (ITU Telecommunication Standardization Sector) Q6/16 VCEG (Video Coding Experts Group)) has progressed with image encoding, originally intended for television conference usage. With H.26L, it has been known that as compared to a conventional encoding format such as MPEG2 or MPEG4, though greater computation amount is requested for encoding and decoding thereof, higher encoding efficiency is realized. Also, currently, as part of activity of MPEG4, standardization for also taking advantage of a function that is not supported by H.26L with this H.26L taken as a base, to realize higher encoding efficiency, has been performed as Joint Model of Enhanced-Compression Video Coding. As a schedule of standardization, H.264 and MPEG4 Part10 (AVC (Advanced Video Coding)) become an international standard in March, 2003.

Further, as an extension thereof, standardization of FRExt (Fidelity Range Extension) including a coding tool necessary for business use such as RGB, 4:2:2, or 4:4:4, and 8×8DCT (Discrete Cosine Transform) and quantization matrix stipulated by MPEG2, has been performed, and accordingly, H.264/AVC has become an encoding format capable of suitably expressing even film noise included in movies, and has been employed for wide ranging applications such as Blu-Ray Disc (registered trademark) and so forth.

However, nowadays, needs for further high-compression encoding have increased, such as demands to compress an image having around 4000×2000 pixels, which is quadruple of a high-vision image, or demands to distribute a high-vision image within an environment with limited transmission capacity like the Internet. Therefore, with the above-mentioned VCEG under ITU-T, studies relating to improvement of encoding efficiency have continuously been performed.

Now, one factor that can be given why the H.264/AVC format realizes high encoding efficiency as compared to the conventional MPEG2 format or the like is employing intra prediction processing.

With the H.264/AVC format, the intra prediction modes of nine kinds of 4×4 pixel and 8×8 pixel block units, and four kinds of 16×16 pixel macroblock units are determined regarding luminance signals. Also, the intra prediction modes of four kinds of 8×8 pixel block units are determined regarding color difference signals. The intra prediction modes for color difference signals may be set independently from the intra prediction modes for luminance signals.

With regard to the 4×4 pixel and the 8×8 pixel intra prediction modes for luminance signals, one intra prediction mode is set for each 4×4 pixel and 8×8 pixel luminance signal block. With regard to the 16×16 pixel intra prediction mode for luminance signals and the intra prediction modes for color difference signals, one prediction mode is set as to one macroblock.

In recent years, methods for further improving the efficiency of intra prediction with this H.264/AVC format have been proposed (e.g., NPL 1 and NPL2).

### CITATION LIST

### Non Patent Literature

NPL 1: “Intra Prediction by Template Matching”, T. K. Tan et al, ICIP 2006
NPL 2: “Tools for Improving Texture and Motion Compensation”, MPEG Workshop, October 2008

### SUMMARY OF INVENTION

### Technical Problem

However, the compression rate with the H.264/AVC format is still insufficient, and there has been need for further reduction of information in compression.

The present invention has been made in light of this situation, and it is an object hereof to further improve encoding efficiency.

### Solution to Problem

One aspect of the present invention is an image processing device including: plane approximating means which, with regard to a block to be processed of image data to which intra-screen encoding is to be performed, approximate the pixel values using a function indicating a plane, and obtain plane parameters which are coefficients of the function indicating the plane, using the pixel values of the block to be processed; plane generating means which generate the plane on the block to be processed as a prediction image, by obtaining pixel values on the plane represented by the plane parameters obtained by the plane approximating means; computing means which subtract, from pixel values of the block to be processed, pixel values of the plane generated by the plane generating means as the prediction image, thereby generating difference data; and encoding means which encode the difference data generated by the computing means.

The image processing device may further include: orthogonal transform means which perform orthogonal transform of the difference data generated by the computing means; and quantizing means which quantize coefficient data generated by the difference data being subjected to orthogonal transform by the orthogonal transform means; wherein the encoding means encode the coefficient data quantized by the quantizing means.

The plane approximating means may obtain the plane parameters by solving smallest squares using pixel values of the block to be processed.

The image processing device may further include: transmitting means which transmit the plane parameters obtained by the plane approximating means.

The image processing device may further include: prediction encoding means which calculate prediction values of the plane parameters, and subtract, from the plane parameters obtained by the plane approximating means, the prediction values; wherein the transmitting means transmit the plane parameters subtracted by the prediction encoding means.

The prediction encoding means may predict the plane parameters of the block to be processed, using plane parameters of a neighboring block of the block to be processed.

The prediction encoding means may take, as the prediction values, the plane parameters of the approximated plane of the block to be processed calculated in a plane mode of intra prediction modes.

The image processing device may further include: orthogonal transform means which perform orthogonal transform of the plane parameters obtained by the plane approximation means; and plane parameter encoding means which encode the plane parameters subjected to orthogonal transform by the orthogonal transform means.

Also, one aspect of the present invention is an image processing method of an image processing device, the method including: plane approximating means of the image processing device, with regard to a block to be processed of image data to which intra-screen encoding is to be performed, approximating the pixel values using a function indicating a plane, and obtaining plane parameters which are coefficients of the function indicating the plane using the pixel values of the block to be processed; plane generating means of the image processing device generating the plane on the block to be processed as a prediction image, by obtaining pixel values on the plane represented by the obtained plane parameters; computing means of the image processing device subtracting, from pixel values of the block to be processed, pixel values of the generated plane as the prediction image, thereby generating difference data; and encoding means of the image processing device encoding the generated difference data.

Another aspect of the present invention is an image processing device including: decoding means which decode encoded data, in which difference data between image data and a prediction image intra-predicted using the image data itself has been encoded; plane generating means which, using plane parameters which are coefficients of a function indicating a plane approximating the pixel values of a block to be processed of the image data, generate the prediction image made up of the plane; and computing means which add the prediction image generated by the plane generating means to the difference data obtained by being decoded by the decoding means.

The image processing device may further include: inverse quantizing means which perform inverse quantizing of the difference data; and inverse orthogonal transform means which perform inverse orthogonal transform of the difference data subjected to inverse quantizing by the inverse quantizing means; wherein the computing means add the prediction image to the difference data subjected to inverse orthogonal transform by the inverse orthogonal transform means.

The plane parameters may have prediction values subtracted therefrom; the image processing device further including: prediction decoding means which perform prediction decoding of the plane parameters by calculating the prediction values and adding the prediction values to the plane parameters from which the prediction values have been subtracted; and the plane generating means generating the prediction image using the plane parameters prediction-decoded by the prediction decoding means.

The prediction decoding means may calculate the prediction values using plane parameters of a neighboring block of the block to be processed.

The prediction decoding means may calculate, as the prediction values, the plane parameters of the approximated plane of the block to be processed, in a plane mode of intra prediction modes.

The image processing device may further include: inverse transform means which perform inverse orthogonal transform of the plane parameters subjected to orthogonal transform; wherein the plane generating means generate the prediction image using the plane parameters subjected to inverse orthogonal transform by the inverse transform means.

Also, another aspect of the present invention is an image processing method of an image processing device, the method including: decoding means of the image processing device decoding encoded data, in which difference data between image data and a prediction image intra-predicted using the image data itself has been encoded; plane generating means of the image processing device using plane parameters which are coefficients of a function indicating a plane approximating the pixel values of a block to be processed of the image data to generate the prediction image made up of the plane; and computing means of the image processing device adding the generated prediction image to the obtained difference data.

According to one aspect of the present invention, with regard to a block to be processed of image data to which intra-screen encoding is to be performed, the pixel values are approximated using a function indicating a plane, and plane parameters which are coefficients of the function indicating the plane are obtained using the pixel values of the block to be processed, the plane on the block to be processed as a prediction image is generated by obtaining pixel values on the plane represented by the obtained plane parameters, pixel values of the generated plane as the prediction image are subtracted from pixel values of the block to be processed, thereby generating difference data, and the generated difference data is encoded.

According to another aspect of the present invention, encoded data, in which difference data between image data and a prediction image intra-predicted using the image data itself has been encoded, is decoded, plane parameters which are coefficients of a function indicating a plane approximating the pixel values of a block to be processed of the image data are used to generate the prediction image made up of the plane, and the generated prediction image is added to the difference data obtained by being decoded.

### Advantageous Effects of Invention

According to the present invention, encoding of image data, or, decoding of encoded image data, can be performed. In particular, encoding efficiency can be further improved.

### BRIEF DESCRIPTION OF DRAWINGS

FIG. 1 is a block diagram illustrating a primary configuration example of an image encoding device to which the present invention has been applied.

FIG. 2 is a diagram illustrating examples of macroblocks.

FIG. 3 is a block diagram illustrating a primary configuration example of an intra prediction unit.

FIG. 4 is a diagram describing an example of how orthogonal transform works.

FIG. 5 is a diagram for describing an example of the 4×4 pixel intra prediction mode.

FIG. 6 is a diagram for describing an example of the 8×8 pixel intra prediction mode.

FIG. 7 is a diagram for describing an example of the 16×16 pixel intra prediction mode.

FIG. 8 is a block diagram illustrating a primary configuration example of a plane prediction image generating unit.

FIG. 9 is a diagram illustrating an example of an approximation plane.

FIG. 10 is a diagram illustrating an example of a method to calculate plane parameters.

FIG. 11 is a diagram illustrating an example of a method to calculate plane parameters.

FIG. 12 is a block diagram illustrating a primary configuration example of a prediction encoding unit.

FIG. 13 is a diagram for describing an example of prediction computation.

FIG. 14 is a block diagram illustrating a primary configuration example of an entropy encoding unit.

FIG. 15 is a flowchart for describing an example of the flow of encoding processing.

FIG. 16 is a flowchart for describing an example of the flow of prediction processing.

FIG. 17 is a flowchart for describing an example of the flow of intra prediction processing.

FIG. 18 is a flowchart for describing an example of the flow of prediction image generating processing.

FIG. 19 is a flowchart for describing an example of the flow of prediction encoding processing.

FIG. 20 is a block diagram illustrating a primary configuration example of an image decoding device to which the present invention has been applied.

FIG. 21 is a block diagram illustrating a primary configuration example of an intra prediction unit.

FIG. 22 is a block diagram illustrating a primary configuration example of a prediction decoding unit.

FIG. 23 is a flowchart for describing an example of the flow of decoding processing.

FIG. 24 is a flowchart for describing an example of the flow of prediction processing.

FIG. 25 is a flowchart for describing an example of the flow of intra prediction processing.

FIG. 26 is a flowchart for describing an example of the flow of prediction decoding processing.

FIG. 27 is a block diagram illustrating another configuration example of a prediction encoding unit.

FIG. 28 is a flowchart for describing another example of the flow of prediction encoding processing.

FIG. 29 is a block diagram illustrating another configuration example of a prediction decoding unit.

FIG. 30 is a flowchart for describing an example of the flow of prediction decoding processing.

FIG. 31 is a diagram describing an example of how transform processing works.

FIG. 32 is a block diagram illustrating another configuration example of a plane prediction image generating unit.

FIG. 33 is a block diagram illustrating a primary configuration example of a transform unit.

FIG. 34 is a flowchart for describing another example of the flow of prediction image generating processing.

FIG. 35 is a flowchart for describing an example of the flow of transform processing.

FIG. 36 is a block diagram illustrating another configuration example of intra prediction unit.

FIG. 37 is a block diagram illustrating a primary configuration example of an inverse transform unit.

FIG. 38 is a flowchart for describing another example of the flow of intra prediction processing.

FIG. 39 is a flowchart for describing an example of the flow of inverse transform processing.

FIG. 40 is a diagram for describing another example of macroblocks.

FIG. 41 is a block diagram illustrating a primary configuration example of a personal computer to which the present invention has been applied.

FIG. 42 is a block diagram illustrating a primary configuration example of a television receiver to which the present invention has been applied.

FIG. 43 is a block diagram illustrating a primary configuration example of a cellular phone to which the present invention has been applied.

FIG. 44 is a block diagram illustrating a primary configuration example of a hard disk recorder to which the present invention has been applied.

FIG. 45 is a block diagram illustrating a primary configuration example of a camera to which the present invention has been applied.

### DESCRIPTION OF EMBODIMENTS

Hereinafter, embodiments of the present invention (hereinafter referred to as embodiments) will be described. Note that description will proceed in the following order.

1. First Embodiment (image encoding device)
2. Second Embodiment (image decoding device)
3. Third Embodiment (image encoding device)
4. Fourth Embodiment (image decoding device)
5. Fifth Embodiment (image encoding device)
6. Sixth Embodiment (image decoding device)
7. Seventh Embodiment (personal computer)
8. Eighth Embodiment (television receiver)
9. Ninth Embodiment (cellular telephone)
10. Tenth Embodiment (hard disk recorder)
11. Eleventh Embodiment (camera)

### 1. First Embodiment

### [Image Encoding Device]

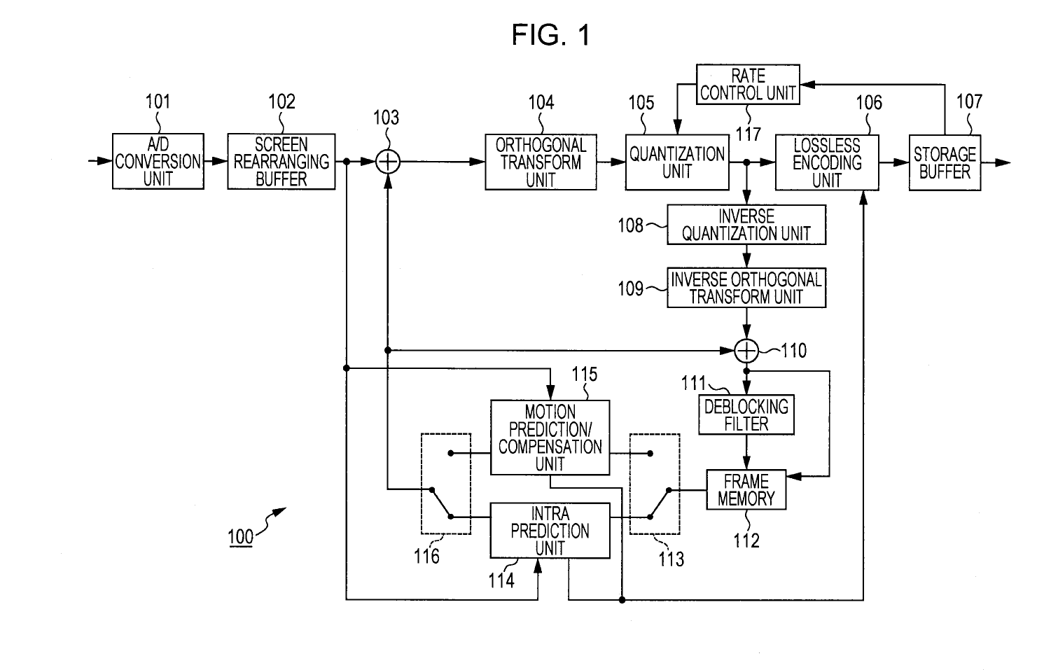

FIG. 1 represents the configuration of an embodiment of an image encoding device serving as an image processing device to which the present invention has been applied.

An image encoding device 100 shown in FIG. 1 is an encoding device which subjects an image to compression encoding using, for example, the H.264 and MPEG (Moving Picture Experts Group) 4 Part10 (AVC (Advanced Video Coding)) (hereafter, called H.264/AVC) format. Note however, that the image encoding device 100 further includes, as an intra prediction mode, a mode wherein prediction is performed using a prediction plane generated using pixels of the block to be processed itself rather than a decoded surrounding block.

With the example in FIG. 1, the image encoding device 100 has an A/D (Analog/Digital) conversion unit 101, a screen rearranging buffer 102, a computing unit 103, an orthogonal transform unit 104, a quantization unit 105, a lossless encoding unit 106, and a storing buffer 107. The image encoding device 100 also has an inverse quantization unit 108, an inverse orthogonal transform unit 109, and a computing unit 110. Further, the image encoding device 100 has a deblocking filter 111, and frame memory 112. Also, the image encoding device 100 has a selecting unit 113, an intra prediction unit 114, a motion prediction/compensation unit 115, and a selecting unit 116. Further, the image encoding device 100 has a rate control unit 117.

The A/D conversion unit 101 performs A/D conversion of input image data, and outputs to the screen rearranging buffer 102 and stores. The screen rearranging buffer 102 rearranges the images of frames in the stored order for display into the order of frames for encoding according to GOP (Group of Picture) structure. The screen rearranging buffer 102 supplies the images of which the frame order has been rearranged to the computing unit 103, intra prediction unit 114, and motion prediction/compensation unit 115.

The computing unit 103 subtracts, from the image read out from the screen rearranging buffer 102, the prediction image supplied from the selecting unit 116, and outputs difference information thereof to the orthogonal transform unit 104. For example, in the case of an image regarding which intra encoding has performed, the computing unit 103 adds the prediction image supplied from the intra prediction unit 114 to the image read out from the screen rearranging buffer 102. Also, for example, in the case of inter encoding having been performed, the computing unit 103 adds the prediction image supplied from the motion prediction/compensation unit 115 to the image read out from the screen rearranging buffer 102.

The orthogonal transform unit 104 subjects the difference information from the computing unit 103 to orthogonal transform, such as discrete cosine transform, Karhunen-Loéve transform, or the like, and supplies a transform coefficient thereof to the quantization unit 105. The quantization unit 105 quantizes the transform coefficient that the orthogonal transform unit 104 outputs. The quantization unit 105 supplies the quantized transform coefficient to the lossless encoding unit 106.

The lossless encoding unit 106 subjects the quantized transform coefficient to lossless encoding, such as variable length coding, arithmetic coding, or the like.

The lossless encoding unit 106 obtains information indicating intra prediction, parameters relating to a latter-described prediction plane (plane parameters), and so forth from the intra prediction unit 114, and obtains information indicating an inter prediction mode and so forth from the motion prediction/compensation unit 115. Note that the information indicating intra prediction will also be referred to as intra prediction mode information hereinafter. Also, the information indicating information mode indicating inter prediction will also be referred to as inter prediction mode information hereinafter.

The lossless encoding unit 106 encodes the quantized transform coefficient, and also takes filter coefficients, intra prediction mode information, inter prediction mode information, quantization parameters, and plane parameters and so forth, as part of header information in the encoded data (multiplexes). The lossless encoding unit 106 supplies the encoded data obtained by encoding to the storing buffer 107 for storage.

For example, with the lossless encoding unit 106, lossless encoding processing, such as variable length coding, arithmetic coding, or the like, is performed. Examples of the variable length coding include CAVLC (Context-Adaptive Variable Length Coding) stipulated by the H.264/AVC format. Examples of the arithmetic coding include CABAC (Context-Adaptive Binary Arithmetic Coding).

The storing buffer 107 temporarily holds the encoded data supplied from the lossless encoding unit 106, and at a predetermined timing outputs this to, for example, a recording device or transmission path or the like downstream not shown in the drawing, as an encoded image encoded by the H.264/AVC format.

Also, the quantized transform coefficient output from the quantization unit 105 is also supplied to the inverse quantization unit 108. The inverse quantization unit 108 performs inverse quantization of the quantized transform coefficient with a method corresponding to quantization at the quantization unit 105, and supplies the obtained transform coefficient to the inverse orthogonal transform unit 109.

The inverse orthogonal transform unit 109 performs inverse orthogonal transform of the supplied transform coefficients with a method corresponding to the orthogonal transform processing by the orthogonal transform unit 104. The output subjected to inverse orthogonal transform is supplied to the computing unit 110.

The computing unit 110 adds the inverse orthogonal transform result supplied from the inverse orthogonal transform unit 109, i.e., the restored difference information, to the prediction image supplied from the selecting unit 116, and obtains a locally decoded image (decoded image). In the event that the difference information corresponds to an image regarding which intra encoding is to be performed, for example, the computing unit 110 adds the prediction image supplied from the intra prediction unit 114 to that difference information. Also, in the event that the difference information corresponds to an image regarding which inter encoding is to be performed, for example, the computing unit 110 adds the prediction image supplied from the motion prediction/compensation unit 115 to that difference information.

The addition results thereof are supplied to the deblocking filter 111 or frame memory 112.

The deblocking filter 111 removes block noise from the decoded image by performing deblocking filter processing as appropriate, and also performs image quality improvement by performing loop filter processing as appropriate using a Wiener filter (Wiener Filter)), for example. The deblocking filter 111 performs class classification of each of the pixels, and performs appropriate filter processing for each class. The deblocking filter 111 then supplies the filter processing results to the frame memory 112.

The frame memory 112 outputs the stored reference image to the intra prediction unit 114 or the motion prediction/compensation unit 115 via the selecting unit 113 at a predetermined timing.

For example, in the case of an image regarding which intra encoding is to be performed, for example, the frame memory 112 supplies the reference image to the intra prediction unit 114 via the selecting unit 113. Also, in the case of an image regarding which inter encoding is to be performed, for example, the frame memory 112 supplies the reference image to the motion prediction/compensation unit 115 via the selecting unit 113.

With this image encoding device 100, the I picture, B picture, and P picture from the screen rearranging buffer 102 are supplied to the intra prediction unit 114 as an image to be subjected to intra prediction (also referred to as intra processing), for example. Also, the B picture and P picture read out from the screen rearranging buffer 102 are supplied to the motion prediction/compensation unit 115 as an image to be subjected to inter prediction (also referred to as inter processing).

The selecting unit 113 supplies the reference image supplied from the frame memory 112 to the intra prediction unit 114 in the case of an image regarding which intra encoding is to be performed, and supplies to the motion prediction/compensation unit 115 in the case of an image regarding which inter encoding is to be performed.

The intra prediction unit 114 performs intra prediction to generate a prediction image using pixel values within the screen (intra screen prediction). The intra prediction unit 114 performs intra prediction by multiple modes (intra prediction modes).

The intra prediction modes include a mode for generating a prediction image based on a reference image supplied from the frame memory 112 via the selecting unit 113. The intra prediction modes also include a mode for generating a prediction image using the image for intra prediction itself read out from the screen rearranging buffer 102 (pixel values of the block to be processed).

The intra prediction unit 114 generates prediction images in all intra prediction modes, evaluates the prediction images, and selects an optimal mode. Upon selecting an optimal intra prediction mode, the intra prediction unit 114 supplies the prediction image generated in that optimal mode to the calculating unit 103 via the selecting unit 116.

Also, as described above, the intra prediction unit 114 supplies information such as intra prediction mode information indicating the intra prediction mode employed, plane parameters of the prediction image, and so forth, to the lossless encoding unit 106 as appropriate.

With regard to the image to be subjected to inter encoding, the motion prediction/compensation unit 115 uses the input image supplied from the screen rearranging buffer 102 and decoded image serving as the reference frame supplied from the frame memory 112 via the selecting unit 113, and calculates a motion vector. The motion prediction/compensation unit 115 performs motion compensation processing according to the calculated motion vector, and generates a prediction image (inter prediction image information).

The motion prediction/compensation unit 115 performs inter prediction processing for all candidate inter prediction modes, and generates prediction images. The motion prediction/compensation unit 115 supplies the generated prediction image to the computing unit 103 via the selecting unit 116.

The motion prediction/compensation unit 115 supplies inter prediction mode information indicating the inter prediction mode that has been employed, and the motion vector information indicating the calculated motion vector, to the lossless encoding unit 106.

The selecting unit 116 supplies the output of the intra prediction unit 114 to the computing unit 103 in the case of an image for performing intra encoding, and supplies the output of the motion prediction/compensation unit 115 to the computing unit 103 in the case of performing inter encoding.

The rate control unit 117 controls the rate of quantization operations of the quantization unit 105 based on the compressed image stored in the storing buffer 107, such that overflow or underflow does not occur.

### [Macroblocks]

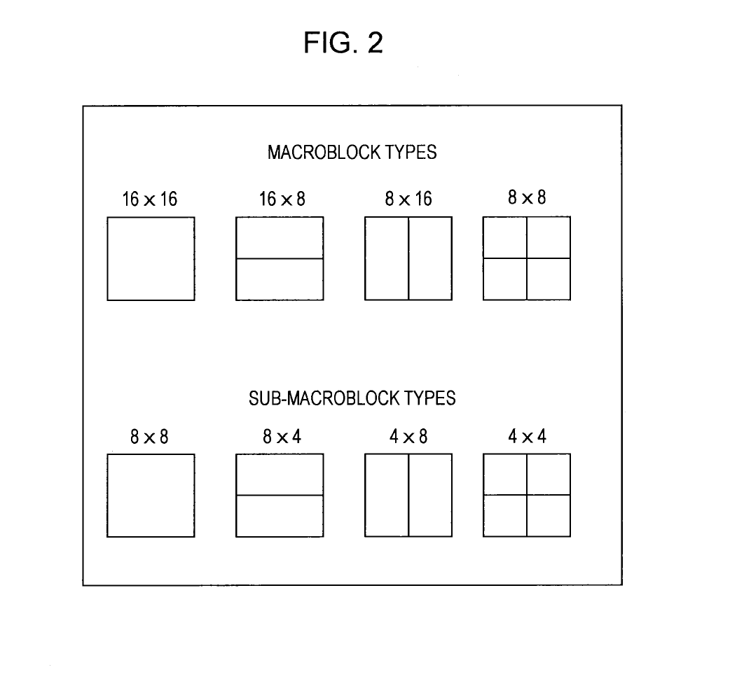

FIG. 2 is a diagram illustrating an example of block sizes for motion prediction/compensation in the H.264/AVC format. With the H.264/AVC format, motion prediction/compensation is performed with the block sizes being variable.

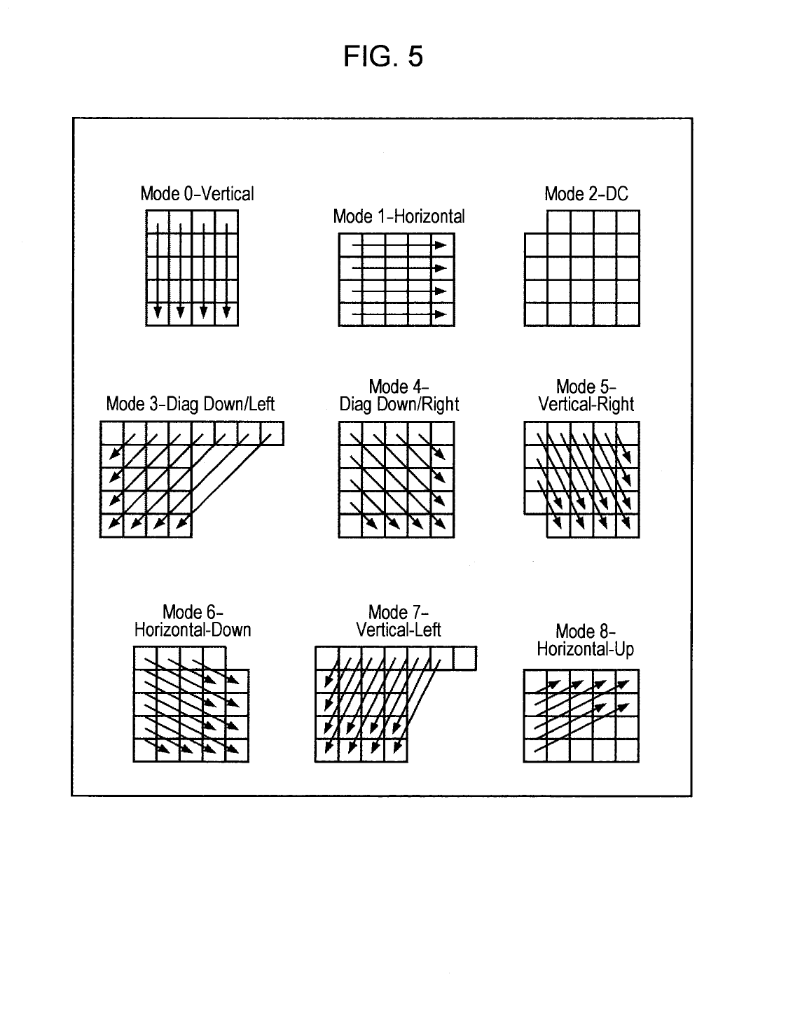

Macroblocks made up of 16×16 pixels divided into partitions of 16×16 pixels, 16×8 pixels, 8×16 pixels, and 8×8 pixels are shown from the left in order on the upper tier in FIG. 2. Also, blocks made up of 8×8 pixels divided into sub partitions of 8×8 pixels, 8×4 pixels, 4×8 pixels, and 4×4 pixels are shown from the left in order on the lower tier in FIG. 5.

That is to say, with the H.264/AVC format, one macroblock may be divided into partitions of one of 16×16 pixels, 16×8 pixels, 8×16 pixels, and 8×8 pixels, with each having independent motion vector information. Also, regarding 8×8 pixel partitions, this may be divided into sub partitions of one of 8×8 pixels, 8×4 pixels, 4×8 pixels, and 4×4 pixels, with each having independent motion vector information.

### [Intra Prediction Unit]

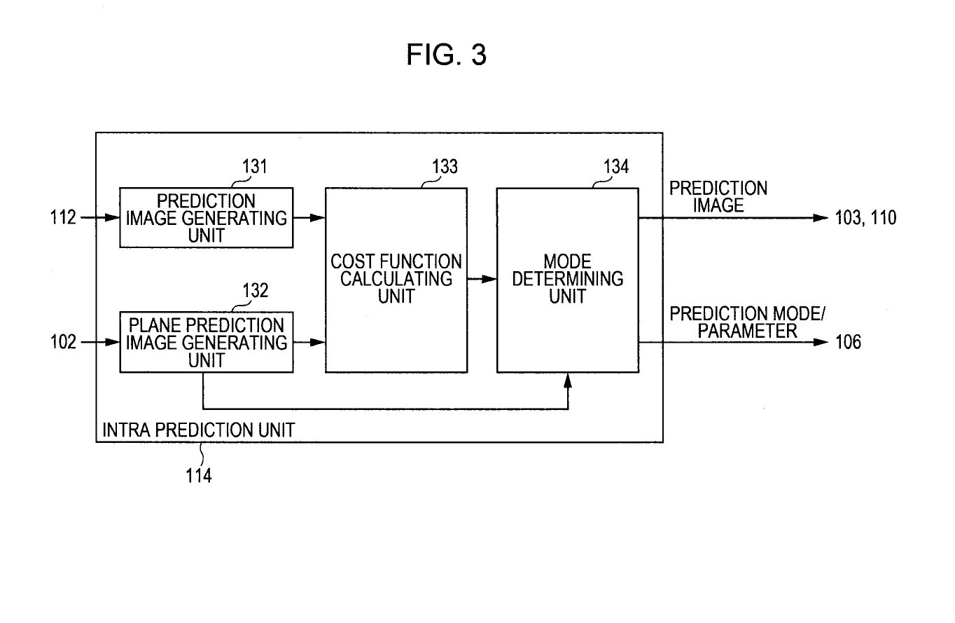

FIG. 3 is a block diagram illustrating a primary configuration example of the intra prediction unit 114 in FIG. 1.

As shown in FIG. 3, the intra prediction unit 114 includes a prediction image generating unit 131, a plane prediction image generating unit 132, a cost function calculating unit 133, and a mode determining unit 134.

As described earlier, the intra prediction unit 114 has both a mode for generating a prediction image using a reference image (surrounding pixels) obtained from the frame memory 112, and a mode for generating a prediction image using the image to be processed itself. Of these, the prediction image generating unit 131 generates a prediction image using a reference image (surrounding pixels) obtained from the frame memory 112. On the other hand, the plane prediction image generating unit 132 generates a prediction image using the image to be processed itself.

A prediction image generated by either the prediction image generating unit 131 or the plane prediction image generating unit 132 is supplied to the cost function calculating unit 133.

The cost function calculating unit 133 calculates cost function values for the prediction image generated by the prediction image generating unit 131, for each intra prediction mode of 4×4 pixels, 8×8 pixels, and 16×16 pixels. Also, the cost function calculating unit 133 calculates cost function values for the prediction image generated by the plane prediction image generating unit 132 for the 16×16 pixel intra prediction mode.

Now, calculation of a cost function value is performed based on one of the techniques of a High Complexity mode or Low Complexity mode. These modes are determined in JM (Joint Model) that is reference software in the H.264/AVC format.

Specifically, in the High Complexity mode, tentatively, up to encoding processing is performed as to all of the candidate prediction modes. A cost function value represented with the following Expression (1) is calculated as to the prediction modes, and a prediction mode that provides the minimum value thereof is selected as the optimal prediction mode.

Cost(Mode)=D+λ·R (1)

In Expression (1), D represents the difference (distortion) between the original image and a decoded image, R represents a generated code amount including an orthogonal transform coefficient, and λ represents a LaGrange multiplier to be provided as a function of a quantization parameter QP.

On the other hand, in the Low Complexity mode, a prediction image is generated, and up to header bits of motion vector information, prediction mode information, flag information, and so forth are calculated as to all of the candidate prediction modes. A cost function value represented with the following Expression (2) is calculated as to the prediction modes, and a prediction mode that provides the minimum value thereof is selected as the optimal prediction mode.

Cost(Mode)=D+QPtoQuant(QP)+Header_Bit (2)

In expression (2), D represents difference (distortion) between the original image and a decoded image, Header_Bit represents header bits as to a prediction mode, and QPtoQuant is a function provided as a function of the quantization parameter QP.

In the Low Complexity mode, a prediction image is only generated as to all of the prediction modes, and there is no need to perform encoding processing and decoding processing, and accordingly, calculation amount can be reduced.

The cost function calculating unit 133 supplies the cost function values calculated in this way to the mode determining unit 134. The mode determining unit 134 selects an optimal intra prediction mode based on the supplied cost function values. That is to say, a mode of which the cost function value is the smallest is selected from the intra prediction modes as the optimal intra prediction mode.

The mode determining unit 134 supplies the prediction image of the prediction mode selected as the optimal intra prediction mode to the calculating unit 103 and computing unit 110 via the selecting unit 166 as necessary. Also, the mode determining unit 134 supplies information of that prediction mode to the lossless encoding unit 106.

Further, in the event that the prediction mode of the plane prediction image generating unit 132 is selected as the optimal intra prediction mode, the mode determining unit 134 obtains the plane parameters thereof from the plane prediction image generating unit 132, and supplies to the lossless encoding unit 106.

### [Orthogonal Transform]

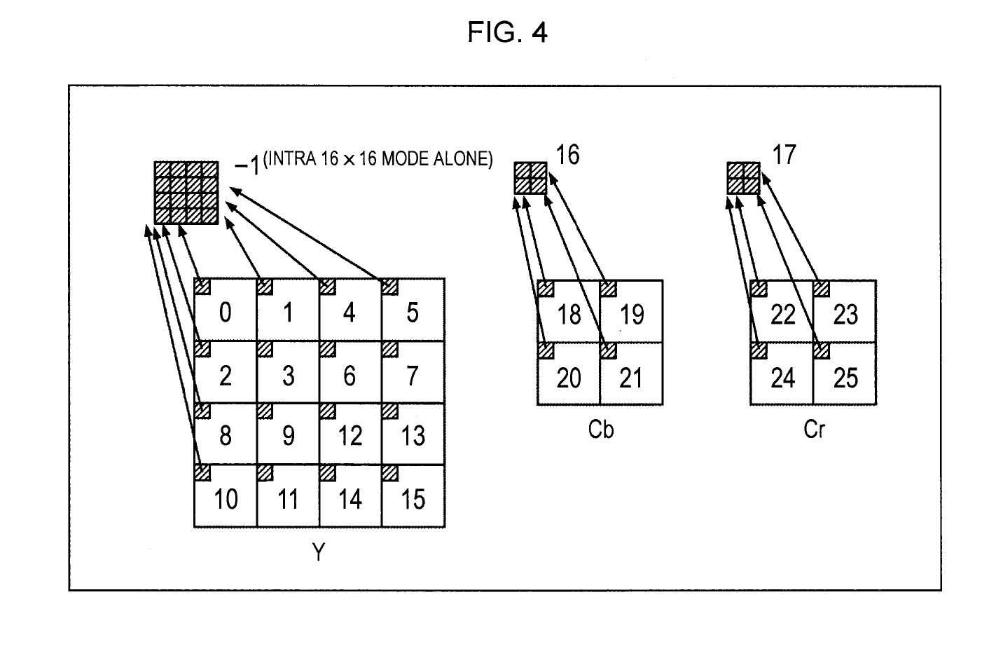

FIG. 4 is a diagram for describing an example of how orthogonal transform works.

With the example in FIG. 4, numerals −1 through 25 appended to the blocks represent the bit stream sequence (processing sequence on the decoding side) of the blocks thereof. Note that, with regard to luminance signals, a macroblock is divided into 4×4 pixels, and DCT of 4×4 pixels is performed. Only in the event of the intra 16×16 prediction mode, as shown in a block −1, the DC components of the blocks are collected, a 4×4 matrix is generated, and this is further subjected to orthogonal transform.

On the other hand, with regard to color difference signals, after a macroblock is divided into 4×4 pixels, and DCT of 4×4 pixels is performed, as shown in the blocks 16 and 17, the DC components of the blocks are collected, a 2×2 matrix is generated, and this is further subjected to orthogonal transform.

Note that, with regard to the intra 8×8 prediction mode, this may be applied to only a case where the current macroblock is subjected to 8×8 orthogonal transform with a high profile or a profile beyond this.

### [Intra Prediction Mode]

Now, prediction processing by the prediction image generating unit 131 will be described. With AVC stipulated in the H.264/AVC format, the prediction image generating unit 131 performs intra prediction on luminance signals with three modes of an intra 4×4 prediction mode, an intra 8×8 prediction mode, and an intra 16×16 prediction mode. These are modes for determining block units, and are set for each macroblock. Also, an intra prediction mode may be set to color difference signals independently from luminance signals for each macroblock.

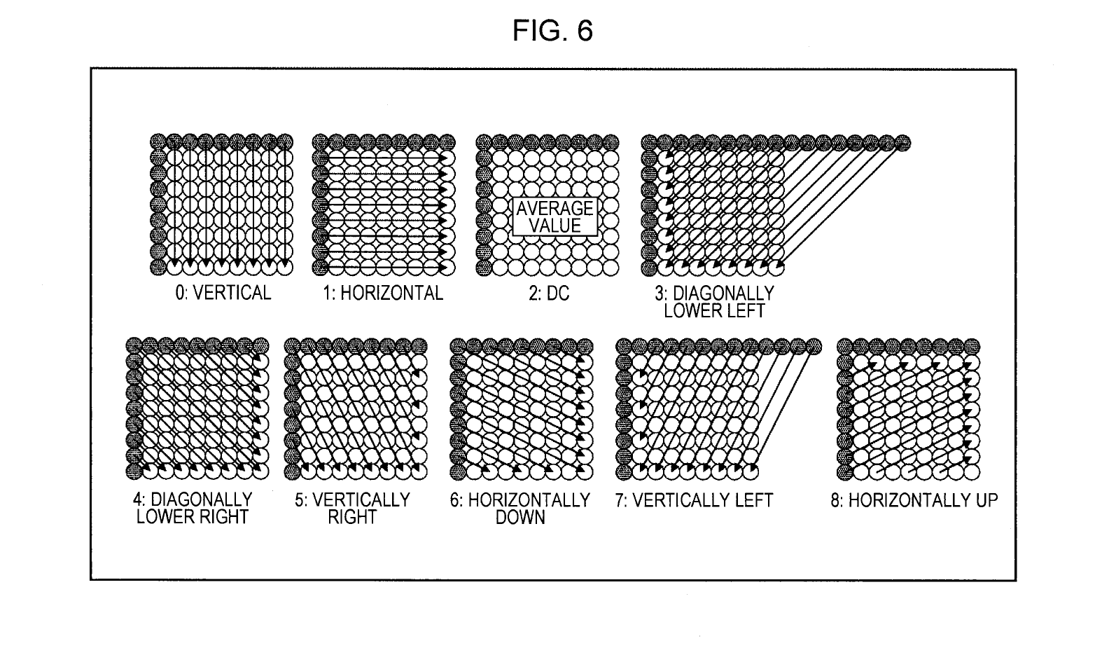

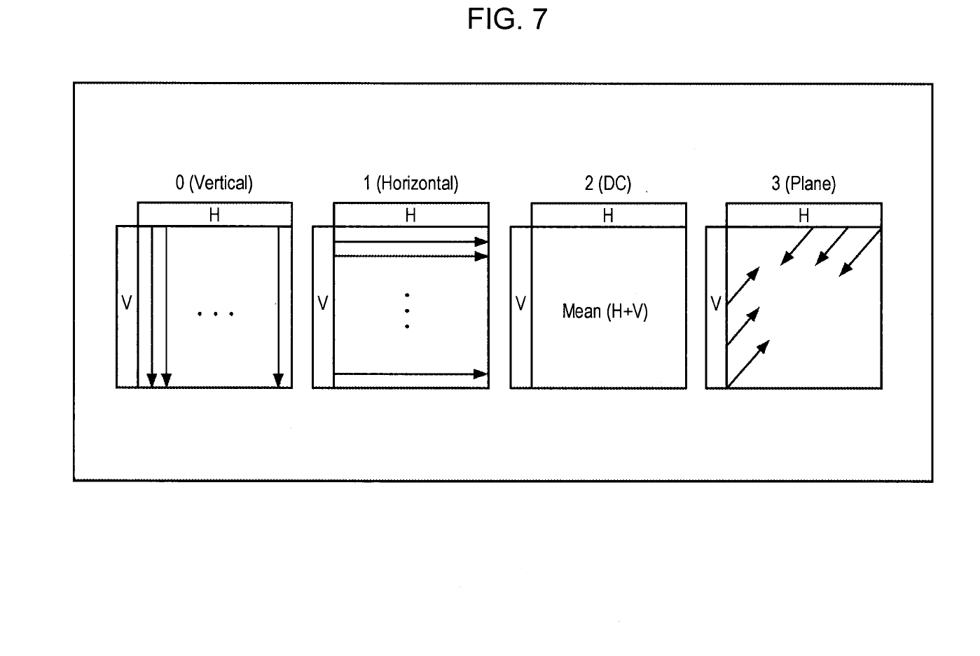

Further, in the event of the intra 4×4 prediction mode, one prediction mode can be set out of the nine kinds of prediction modes for each 4×4 pixel current block, as shown in FIG. 5. In the event of the intra 8×8 prediction mode, one prediction mode can be set out of the nine kinds of prediction modes for each 8×8 pixel current block, as shown in FIG. 6. Also, in the event of the intra 16×16 prediction mode, one prediction mode can be set to a 16×16 pixel current macroblock out of the four kinds of prediction modes, as shown in FIG. 7.

Note that, hereafter, the intra 4×4 prediction mode, intra 8×8 prediction mode, and intra 16×16 prediction mode will also be referred to as 4×4 pixel intra prediction mode, 8×8 pixel intra prediction mode, and 16×16 pixel intra prediction mode as appropriate, respectively.

FIG. 7 is a diagram showing the four kinds of the 16×16 pixel intra prediction modes for luminance signals (Intra_{—}16×16_pred_mode).

A current macroblock to be subjected to intra processing is represented by A, and P(x, y); x, y=−1, 0, . . . , 15 represents the pixel value of a pixel adjacent to the current macroblock A.

The mode 0 is a Vertical Prediction mode, and is applied only when P(x, −1); x, y=−1, 0, . . . , 15 is “available”. In this case, the prediction pixel value Pred(x, y) of each pixel of the current macroblock A is generated as with the following Expression (3).

Pred(x,y)=P(x,−1); x,y=0, . . . , 15 (3)

The mode 1 is a Horizontal Prediction mode, and is applied only when P(−1, y); x, y=−1, 0, . . . , 15 is “available”. In this case, the prediction pixel value Pred(x, y) of each pixel of the current macroblock A is generated as with the following Expression (4).

Pred(x,y)=P(−1,y); x,y=0, . . . , 15 (4)

The mode 2 is a DC Prediction mode, and in the case that all of P(x, −1) and P(−1, y); x, y=−1, 0, . . . , 15 are “available”, the prediction pixel value Pred(x, y) of each pixel of the current macroblock A is generated as with the following Expression (5).

$$\begin{matrix}[ Mathematical Expression 1 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , ⋯ , 15 & ( 5 )\end{matrix}$$

Also, in the event that P(x, −1); x, y=−1, 0, . . . , 15 is “unavailable”, the prediction pixel value Pred(x, y) of each pixel of the current macroblock A is generated as with the following Expression (6).

$$\begin{matrix}[ Mathematical Expression 2 ] & \\ Pred ( x , y ) = [ {\sum }_{{y}^{′} = 0}^{15} P ( - 1 , {y}^{′} ) + 8 ] >> 4 \\ with x , y = 0 , ⋯ , 15 & ( 6 )\end{matrix}$$

In the event that P(−1, y); x, y=−1, 0, . . . , 15 is “unavailable”, the prediction pixel value Pred(x, y) of each pixel of the current macroblock A is generated as with the following Expression (7).

$$\begin{matrix}[ Mathematical Expression 3 ] & \\ Pred ( x , y ) = [ {\sum }_{{y}^{′} = 0}^{15} P ( {x}^{′} , - 1 ) + 8 ] >> 4 \\ with x , y = 0 , ⋯ , 15 & ( 7 )\end{matrix}$$

In the event that all of P(x, −1) and P(−1, y); x, y=−1, 0, . . . , 15 are “unavailable”, 128 is employed as the prediction pixel value.

The mode 3 is a Plane Prediction mode, and is applied only when all of P(x, −1) and P(−1, y); x, y=−1, 0, . . . , 15 are “available”. In this case, the prediction pixel value Pred(x, y) of each pixel of the current macroblock A is generated as with the following Expression (8).

$$\begin{matrix}[ Mathematical Expression 4 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 8 )\end{matrix}$$

The intra prediction modes for color difference signals may be set independently from the intra prediction modes for luminance signals. The intra prediction modes as to color difference signals conform to the above-mentioned 16×16 pixel intra prediction modes for luminance signals.

However, the 16×16 pixel intra prediction modes for luminance signals take a 16×16 pixel block as the object, but on the other hand, the intra prediction modes as to color difference signals take an 8×8 pixel block as the object.

As described above, the intra prediction modes for luminance signals include the nine kinds of prediction modes of 4×4 pixel and 8×8 pixel block units, and the four kinds of prediction modes of 16×16 pixel macroblock units. The modes of these block units are set for each macroblock unit. The intra prediction modes for color difference signals include the four kinds of prediction modes of 8×8 pixel block units. The intra prediction modes for color difference signals may be set independently from the intra prediction modes for luminance signals.

Also, with regard to the 4×4 pixel intra prediction modes (intra 4×4 prediction modes), and the 8×8 pixel intra prediction modes (intra 8×8 prediction modes) for luminance signals, one intra prediction mode is set for each 4×4 pixel and 8×8 pixel luminance signal block. With regard to the 16×16 pixel intra prediction mode (intra 16×16 prediction mode) for luminance signals and the intra prediction modes for color difference signals, one prediction mode is set as to one macroblock.

### [Plane Prediction Image Generating Unit]

In the case of mode 3 (Plane Prediction mode) of the 16×16 pixel intra prediction modes above, a plane of a block to be processed is predicted from a small number of pixels neighboring the block to be processed. Pixel values of the reference image supplied from the frame memory 112 are used for the neighboring pixel values. Further, pixel values of a decoded image are to be used for decoding processing. Accordingly, the prediction precision of this mode is not high, and there is the concern that encoding efficiency may be low as well.

On the other hand, the plane prediction image generating unit 132 performs prediction using the pixel values of the block to be processed of the input image (original image), thereby improving prediction precision, and improving encoding efficiency. However, in this case, the decoding side cannot get the original image, so parameters indicating a predicted plane (plane parameters) are transmitted to the decoding side.

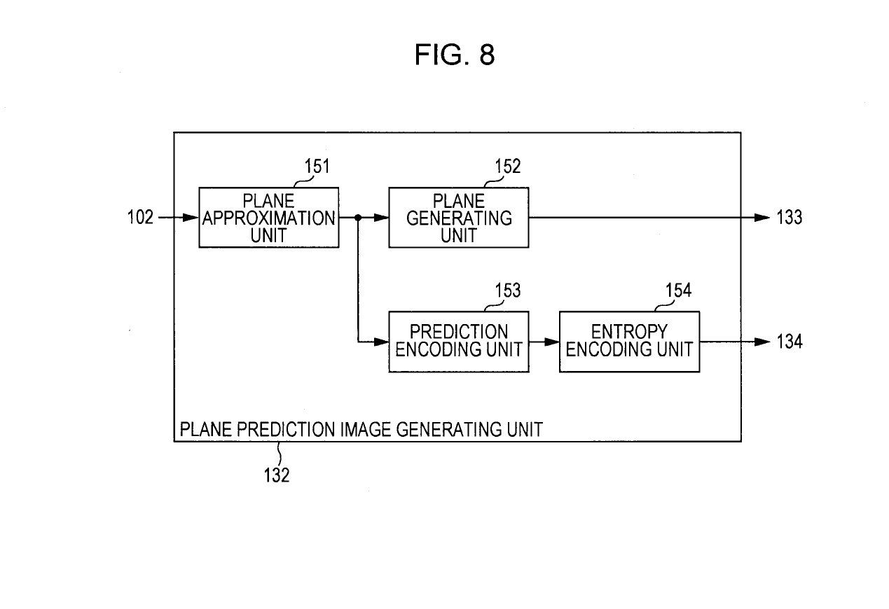

FIG. 8 is a block diagram illustrating a primary configuration example of the plane prediction image generating unit 132 in FIG. 3.

As shown in FIG. 8, the plane prediction image generating unit 132 includes a plane approximation unit 151, a plane generating unit 152, a prediction encoding unit 153, and an entropy encoding unit 154.

The plane approximation unit 151 approximates on a plane the pixel values of the block to be processed that has been read out from the screen rearranging buffer 102. That is to say, the plane approximation unit 151 obtains a plane which approximates the pixel values of the block to be processed. More specifically, the plane approximation unit 151 obtains the coefficients of a function representing a plane approximating the pixel values of the block to be processed (approximation plane). The coefficients of the function representing this approximation plane will be called plane parameters. Upon obtaining the plane parameters, the plane approximation unit 151 supplies these to the plane generating unit 152 and prediction encoding unit 153.

The plane generating unit 152 obtains pixel values on the plane represented by the supplied plane parameters. This plane is a plane approximating the pixel values of the block to be processed. That is to say, the plane generating unit 152 obtains approximation values for the pixel values (values on the plane), thereby generating that plane on the block to be processed. By expressing the plane with the pixel values, the plane generating unit 152 can supply the pixel group to the cost function calculating unit 133.

The plane parameters obtained at the plane approximation unit 151 are necessary for decoding processing, and accordingly are transmitted to the decoding side. Now, to further facilitate transmission, the plane prediction image generating unit 132 performs entropy encoding of the plane parameters. Also, the plane prediction image generating unit 132 further reduces the amount of data of the plane parameters by predicting the values of the plane parameters from other information, before performing this entropy encoding.

The prediction encoding unit 153 performs prediction encoding of the supplied plane parameters, thereby reducing the data amount thereof. The prediction encoding unit 153 predicts the value of the plane parameters, and obtains the difference between the prediction values and the actual plane parameters values, thereby reducing the data amount. The prediction encoding unit 153 supplies the encoding results (encoded plane parameters) to the entropy encoding unit 154.

The entropy encoding unit 154 performs further entropy encoding of the encoded plane parameters. The entropy encoding unit 154 supplies the encoded data to the mode determining unit 134.

### [Approximated Plane]

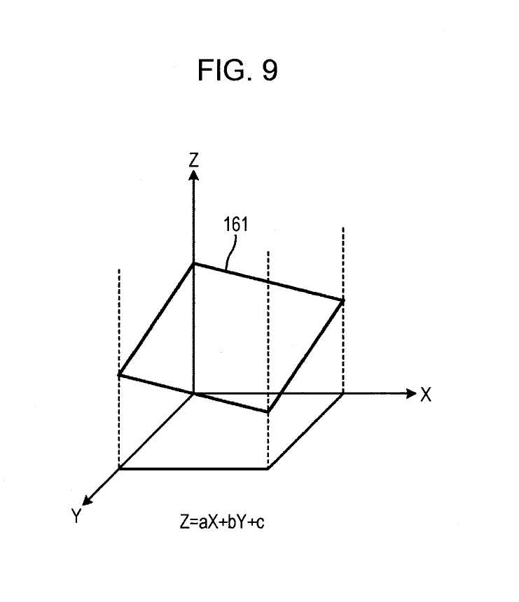

Next, plane approximation will be described. FIG. 9 is a diagram illustrating an example of an approximated plane. As described above, the plane approximation unit 151 generates a plane approximating the pixel values of the block to be processed (approximated plane). As shown in FIG. 9, in an XYZ space, this approximated plane 161 is expressed by a function such as in the following Expression (9).

Z=aX+bY+c (9)

Note that the XY plane represents the coordinates of the pixels of the block to be processed, and the Z axis represents the pixel values. That is to say, the plane approximation unit 151 obtains the approximated plane 161 by obtaining the parameters a, b, and c of the Expression (9).

### [Plane Parameters]

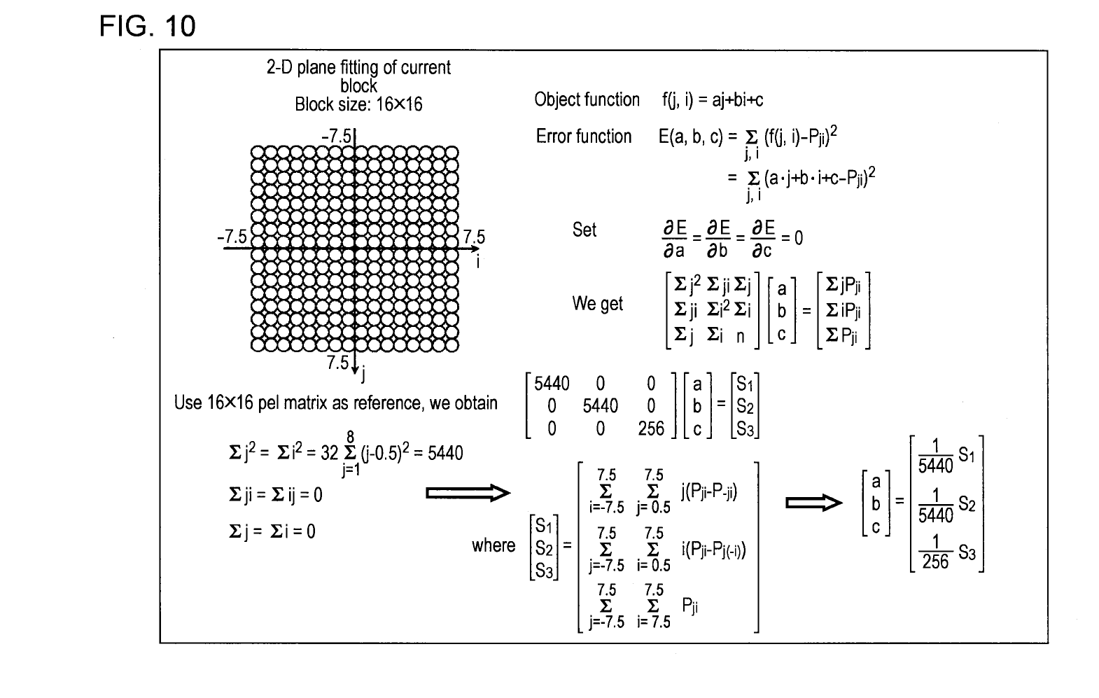

The approximated plane 161 is obtained by solving the least squares of the pixel values of the block to be processed itself. FIG. 10 is a diagram illustrating an example of calculating the plane parameters a, b, and c.

For example, if we say that the block size is 16×16 and we have a ji plane, the object function for obtaining the pixel values f(j, i) on the plane 161 is such as in the following Expression (10).

f(j,i)=aj+bi+c (10)

Accordingly, an error function for obtaining an error value E(a, b, c) indicating the difference between the approximate plane 161 and the actual pixel values is given such as in the following Expression (11).

$$\begin{matrix}[ Mathematical Expression 5 ] & \\ \begin{matrix}E ( a , b , c ) = {\sum }_{j , i} {( f ( j , i ) - {P}_{ji} )}^{2} \\ = {\sum }_{j , i} {( a \cdot j + b \cdot i + c - {P}_{ji} )}^{2}\end{matrix} & ( 11 )\end{matrix}$$

Obtaining the plane parameters a, b, c such that the error value is the smallest yields the plane parameters a, b, c such as shown in the following Expression (12).

$$\begin{matrix}[ Mathematical Expression 6 ] & \\ [ \begin{matrix}a \\ b \\ c\end{matrix} ] = [ \begin{matrix}\frac{1}{5440} {S}_{1} \\ \frac{1}{5440} {S}_{2} \\ \frac{1}{256} {S}_{3}\end{matrix} ] & ( 12 )\end{matrix}$$

Note however, that variables S₁, S₂, and S₃ are such as shown in the following Expression (13).

$$\begin{matrix}[ Mathematical Expression 7 ] & \\ [ \begin{matrix}{S}_{1} \\ {S}_{2} \\ {S}_{3}\end{matrix} ] = [ \begin{matrix}{\sum }_{i = - 7.5}^{7.5} {\sum }_{j = 0.5}^{7.5} j ( {P}_{ji} - {P}_{- ji} ) \\ {\sum }_{j = - 7.5}^{7.5} {\sum }_{i = 0.5}^{7.5} i ( {P}_{ji} - {P}_{j ( - i )} ) \\ {\sum }_{j = - 7.5}^{7.5} {\sum }_{i = 7.5}^{7.5} {P}_{ji}\end{matrix} ] & ( 13 )\end{matrix}$$

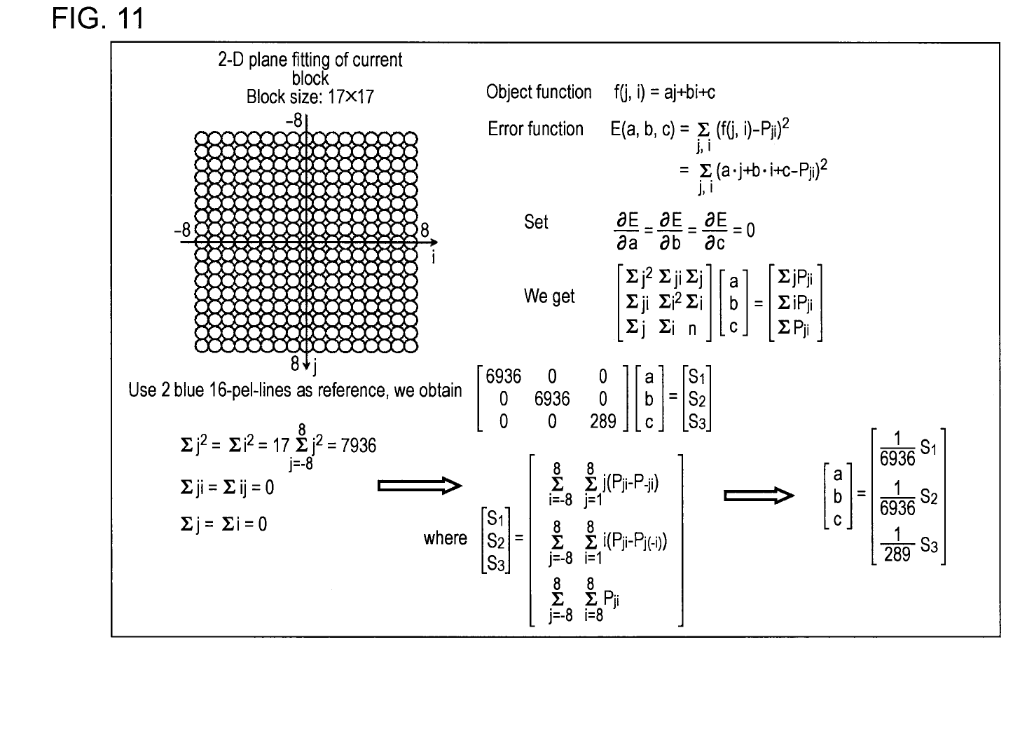

Note that using data of the input image of the image encoding device 100 to be encoded (i.e., the original image) is sufficient for calculation (prediction) of the approximated plane 161. For example, surrounding pixels of the block to be processed may also be used for calculation of the approximated plane 161. In the case of the example in FIG. 11, the plane parameters are obtained using 17×17 pixels including the block to be processed. In this case as well, plane parameters are obtained by solving the least squares in the same way as with the case in FIG. 10.

In this case, obtaining the plane parameters a, b, c such that the error value is the smallest yields the plane parameters a, b, c such as shown in the following Expression (14).

$$\begin{matrix}[ Mathematical Expression 8 ] & \\ [ \begin{matrix}a \\ b \\ c\end{matrix} ] = [ \begin{matrix}\frac{1}{6936} {S}_{1} \\ \frac{1}{6936} {S}_{2} \\ \frac{1}{289} {S}_{3}\end{matrix} ] & ( 14 )\end{matrix}$$

Note however, that variables S₁, S₂, and S₃ are such as shown in the following Expression (15).

$$\begin{matrix}[ Mathematical Expression 9 ] & \\ [ \begin{matrix}{S}_{1} \\ {S}_{2} \\ {S}_{3}\end{matrix} ] = [ \begin{matrix}{\sum }_{i = - 8}^{8} {\sum }_{j = 1}^{8} j ( {P}_{ji} - {P}_{- ji} ) \\ {\sum }_{j = - 8}^{8} {\sum }_{i = 1}^{8} i ( {P}_{ji} - {P}_{j ( - i )} ) \\ {\sum }_{j = - 8}^{8} {\sum }_{i = 8}^{8} {P}_{ji}\end{matrix} ] & ( 15 )\end{matrix}$$

The plane generating unit 152 obtains the pixel values representing the plane 161 indicated by the plane parameters generated as described above.

Note that the way in which the plane 161 is obtained is optional. For example, the plane approximation unit 151 may obtain the plane parameters of the plane 161 with a method other than using least squares.

### [Prediction Encoding Unit]

The plane parameters a, b, c obtained as described above each have values, and there is still room for reducing the data amount by encoding. Particularly, the parameter c is the DC component of the plane 161, so there is a great possibility that the value thereof is great, and there is a great possibility that the data amount can be reduced by prediction encoding.

Now, generally, a case where the encoding efficiency of prediction encoding using plane prediction such as mode 3 (Plane Prediction mode) of the 16×16 pixel intra prediction modes is high, is a case where the frequency component of the image is low. For example, there is a great possibility that such a mode will be employed in a portion where the image gradually changes, such as at a portion where gradation occurs.

That is to say, at portions where plane prediction is useful, there is a great possibility that the correlation between the nature of images is high between the block to be processed and the neighboring block. In other words, there is a great possibility that the correlation between plan parameters of the block to be processed and plane parameters of the neighboring block will also be high.

The prediction encoding unit 153 uses such a nature to predict the plane parameters of the block to be processed from plane parameters of a neighboring block of the block to be processed calculated in the past, and calculates the difference between the prediction values thereof and the values of the plane parameters actually obtained.

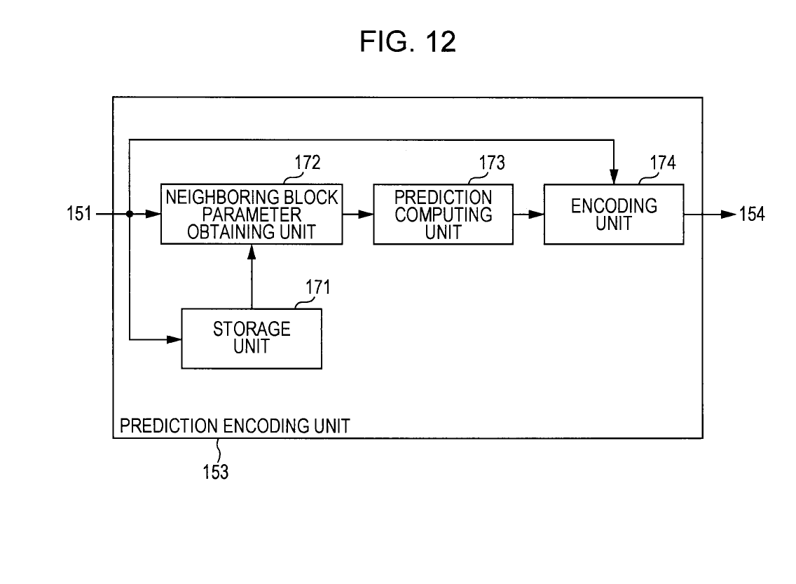

FIG. 12 is a block diagram illustrating a primary configuration example of the prediction encoding unit 153 shown in FIG. 8. As shown in FIG. 12, the prediction encoding unit 153 has a storage unit 171, a neighboring block parameter obtaining unit 172, a prediction computing unit 173, and an encoding unit 174.

The storage unit 171 stores the plane parameters a, b, c obtained by the plane approximation unit 151. There is the possibility that the plane parameters a, b, c stored in the storage unit 171 will be used for another block to be processed at a later time. That is to say, the storage unit 171 stores the plane parameters a, b, c of neighboring blocks obtained in the past.

Upon the plane parameters of the block to be processed being supplied from the plane approximation unit 151, the neighboring block parameter obtaining unit 172 obtains the plane parameters a, b, c of the neighboring block of the block to be processed obtained in the past, from the storage unit 171. The neighboring block parameter obtaining unit 172 supplies the obtained neighboring block plane parameters to the prediction computing unit 173.

The prediction computing unit 173 uses the neighboring block plane parameters to calculate the prediction values of the plane parameters of the block to be processed. The prediction, computing unit 173 supplies the calculated prediction values to the encoding unit 174.

The encoding unit 174 obtains the difference between the plane parameters supplied from the plane approximation unit 151 and the prediction values supplied from the prediction computing unit 173. The encoding unit 174 supplies the difference values to the entropy encoding unit 154 as prediction encoding results.

Next, description will be made regarding the prediction value calculation method by the prediction computing unit 173. This prediction value calculation method is basically optional.

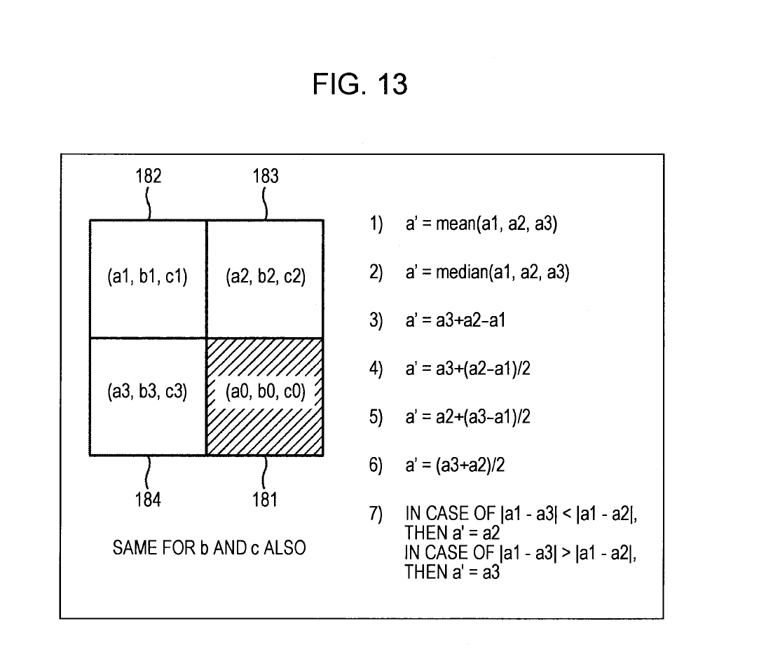

For example, as shown in FIG. 13, we will say that plane parameters of a block to be processed 181, obtained by the plane approximation unit 151, are (a0, b0, c0). We will say that the plane parameters of a block 182 to the diagonal upper left of the block to be processed 181 are (a1, b1, c1). We will also say that the plane parameters of a block 183 above the block to be processed 181 are (a2, b2, c2). We will further say that the plane parameters of a block 184 adjacent to the left of the block to be processed 181 are (a3, b3, c3). We will also say that the prediction values of the plane parameters of the block to be processed 181 are (a′, b′, c′).

The prediction computing unit 173 takes the average values of the plane parameters of the block 182 through block 184 as the prediction values of the plane parameters of the block to be processed 181. For example, the prediction computing unit 173 obtains the average values for the neighboring block for each of the plane parameters a, b, c as shown in the following Expression (16), and takes these as prediction values (1) in FIG. 13).

a′=mean(a1,a2,a3)

b′=mean(b1,b2,b3)

c′=mean(c1,c2,c3) (16)

The prediction computing unit 173 uses these prediction values to calculate prediction encoding results (a″, b″, c″) as with the following Expression (17).

a″=a0−a′

b″=b0−b′

c″=c0−c′ (17)

Note that for example, a median value of the plane parameters of the block 182 through block 184 may be taken as a prediction value. In this case, the prediction computing unit 173 obtains the median value of the adjacent blocks for each of the plane parameters a, b, c as in the following Expression (18), for example (2) in FIG. 13)

a′=median(a1,a2,a3)

b′=median(b1,b2,b3)

c′=median(c1,c2,c3) (18)

Also, the prediction computing unit 173 may use the values of the plane parameters of the block 182 through block 184 by computation such as in the following Expression (19) to obtain the prediction values for the block to be processed (3) in FIG. 13).

a′=a3+a2−a1

b′=b3+b2−b1

c′=c3+c2−c1 (19)

Further, the prediction computing unit 173 may obtain the prediction values of the block to be processed by computation such as in the following Expression (20), using the values of the plane parameters of the block 182 through block 184, for example (4) in FIG. 13).

a′=a3+(a2−a1)/2

b′=b3+(b2−b1)/2

c′=c3+(c2−c1)/2 (20)

Also, the prediction computing unit 173 may obtain the prediction values of the block to be processed by computation such as in the following Expression (21), using the values of the plane parameters of the block 182 through block 184, for example (5) in FIG. 13).

a′=a2+(a3−a1)/2

b′=b2+(b3−b1)/2

c′=c2+(c3−c1)/2 (21)

Further, the prediction computing unit 173 may obtain the prediction values of the block to be processed by computation such as in the following Expression (22), using the values of the plane parameters of the block 182 through block 184, for example (6) in FIG. 13).

a′=(a3+a2)/2

b′=(b3+b2)/2

c′=(c3+c2)/2 (22)

also, the prediction computing unit 173 may set the prediction values of the block to be processed in accordance with conditions of the values of the plane parameters of the block 182 through block 184, such as shown in the following Expression (23), for example (7) in FIG. 13).

In case of |a1−a3|<|a1−a2|, then

a′=a2

b′=b2

c′=c2

In case of |a1−a3|>|a1−a2|, then

a′=a3

b′=b3

c′=c3 (23)

Further, obtaining prediction values may be performed with a method other than described above. Also, the prediction computing unit 173 may obtain prediction values with multiple methods, and select the optimal of the prediction value calculation results (e.g., a value closest to the plane parameters (a0, b0, c0).

### [Entropy Encoding Unit]

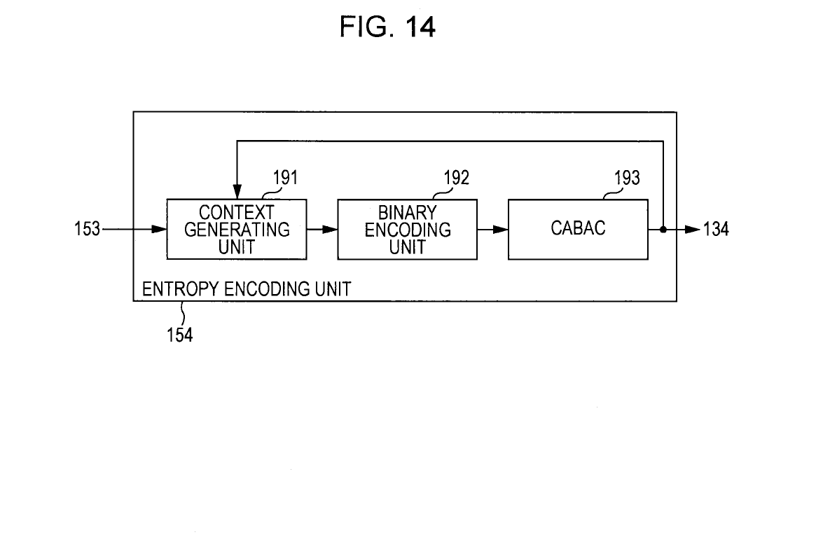

As described above, the plane parameters that have been prediction encoded are entropy encoded by the entropy encoding unit 154. FIG. 14 is a block diagram illustrating a primary configuration example of the entropy encoding unit 154 in FIG. 8.

As shown in FIG. 14, for example, the entropy encoding unit 154 includes a context generating unit 191, a binary encoding unit 192, and a CABAC (Context-based Adaptive Binary Arithmetic Coding) 193.

The context generating unit 191 generates one or multiple contexts in accordance with the results of prediction encoding supplied from the prediction encoding unit 153 and the state of the surrounding blocks, and defines a probability model for each.

The binary encoding unit 192 binarizes the context output that is output from the context generating unit 191. The CABAC 193 performs arithmetic encoding of the binarized context. The encoded data output from the CABAC 193 (encoded plane parameters) is supplied to the mode determining unit 134. Also, the CABAC 193 updates the probability models of the context generating unit 191 based on the encoding results.

### [Encoding Processing]

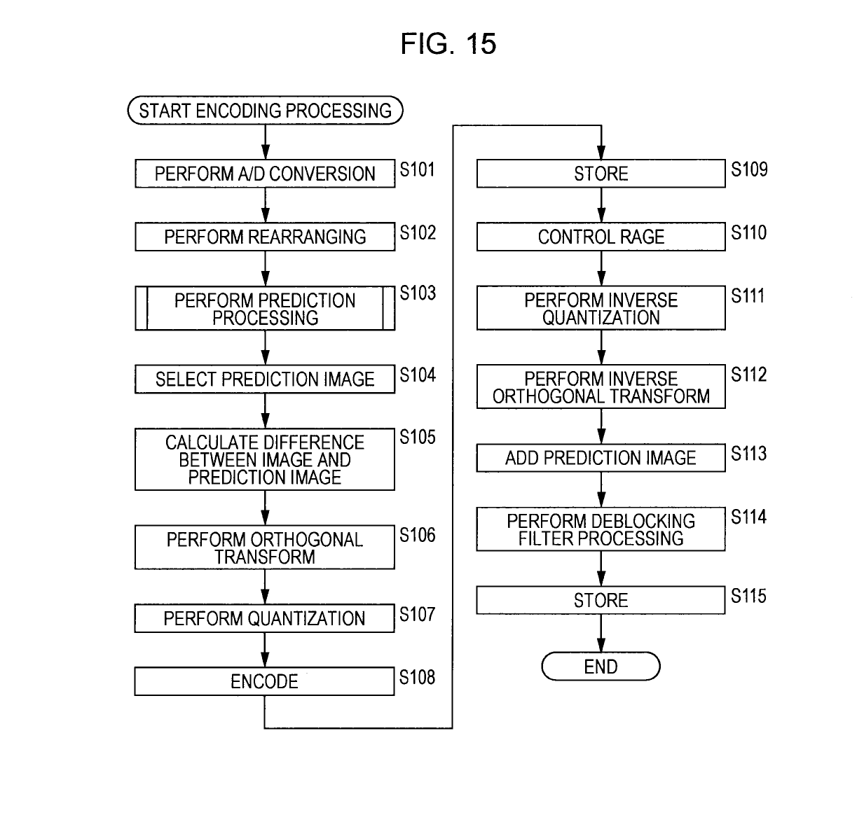

The flow of processing executed by the image encoding device 100 such as described above will be described next. First, an example of the flow of encoding processing will be described with reference to the flowchart in FIG. 15.

In step S101, the A/D conversion unit 101 converts an input image from analog to digital. In step S102, the screen rearranging buffer 102 stores the image supplied from the A/D conversion unit 101, and performs rearranging from the sequence for displaying the pictures to the sequence for encoding.

In step S103, the intra prediction unit 114 and motion prediction/compensation unit 115 each perform prediction processing for the image. That is to say, in step S103, the intra prediction unit 114 performs intra prediction mode intra prediction processing. The motion prediction/compensation unit 115 performs inter prediction mode motion prediction/compensation processing.

In step S104, the selecting unit 116 decides the optimal prediction mode based on the cost function values output from the intra prediction unit 114 and motion prediction/compensation unit 115. That is to say, the selecting unit 116 selects one or the other of the prediction image generated by the intra prediction unit 114 and the prediction image generated by the motion prediction/compensation unit 115.

Also, the selection information of the prediction image is supplied to the intra prediction unit 114 or motion prediction/compensation unit 115. In the event that the prediction image of the optimal intra prediction mode has been selected, the intra prediction unit 114 supplies information indicating the optimal intra prediction mode (i.e., intra prediction mode information) to the lossless encoding unit 106.

Further, in the event that the prediction mode of the plane prediction image generating unit 132 performing prediction using the original image has been selected as the optimal intra prediction mode, the intra prediction unit 114 also supplies the encoded data of the predicted plane parameters to the lossless encoding unit 106 as well.

In the event that the prediction image of the optimal inter prediction mode has been selected, the motion prediction/compensation unit 115 outputs information indicating the optimal inter prediction mode, and information according to the optimal inter prediction mode as necessary, to the lossless encoding unit 106. Examples of information according to the optimal inter prediction mode include motion vector information, flag information, reference frame information, and so forth.

In step S105, the computing unit 103 computes difference between an image rearranged in step S102 and the prediction image obtained by the prediction processing in step S103. The prediction image is supplied to the computing unit 103 from the motion prediction/compensation unit 115 in the event of performing inter prediction, and from the intra prediction unit 114 in the event of performing intra prediction, via the selecting unit 116 in either case.

The difference data is smaller in data amount as compared to the original image data. Accordingly, the data amount can be compressed as compared to the case of encoding the original image without change.

In step S106, the orthogonal transform unit 104 subjects the difference information supplied from the computing unit 103 to orthogonal transform. Specifically, orthogonal transform, such as discrete cosine transform, Karhunen-Loéve transform, or the like, is performed, and a transform coefficient is output. In step S107, the quantization unit 105 quantizes the transform coefficient.

In step S108, the lossless encoding unit 106 encodes the quantized transform coefficient output from the quantization unit 105. That is to say, the difference image (secondary difference image in the case of inter) is subjected to lossless encoding such as variable-length encoding or arithmetic encoding or the like.

Note that the lossless encoding unit 106 encodes information relating to the prediction mode of the prediction image selected by the processing in step S104, and adds to the header information of encoded data obtained by encoding the difference image.

That is to say, the lossless encoding unit 106 also encodes intra prediction mode information supplied from the intra prediction unit 114 or information according to the optimal inter prediction mode supplied from the motion prediction/compensation unit 115 and so forth, and adds this to the header information. Also, in the event that encoded data of the plane parameters is supplied from the intra prediction unit 114, the lossless encoding unit 106 also adds this encoded data to the header information or the like of the encoded data.

In step S109, the storage buffer 107 stores encoded data output from the lossless encoding unit 106. The encoded data stored in the storage buffer 107 is read out as suitable, and transmitted to the decoding side via the transmission path.

In step S110, the rate control unit 117 controls the rate of the quantization operation of the quantization unit 105, based on the compressed image stored in the storage buffer 107, so as not to cause overflow or underflow.

Also, the difference information quantized by the processing in step S107 is locally decoded as follows. That is to say, in step S111, the inverse quantization unit 108 subjects the transform coefficient quantized by the quantization unit 105 to inverse quantization using a property corresponding to the property of the quantization unit 105. In step S112, the inverse orthogonal transform unit 109 subjects the transform coefficient subjected to inverse quantization by the inverse quantization unit 108 to inverse orthogonal transform using a property corresponding to the property of the orthogonal transform unit 104.

In step S113, the computing unit 110 adds the prediction image input via the selecting unit 116 to the locally decoded difference information, and generates a locally decoded image (the image corresponding to the input to the computing unit 103). In step S114, the deblocking filter 111 subjects the image output from the computing unit 110 to filtering. Thus, block distortion is removed. In step S115, the frame memory 112 stores the image subjected to filtering. Note that an image not subjected to filtering processing by the deblocking filter 111 is also supplied from the computing unit 110 to the frame memory 112 for storing.

### [Prediction Processing]

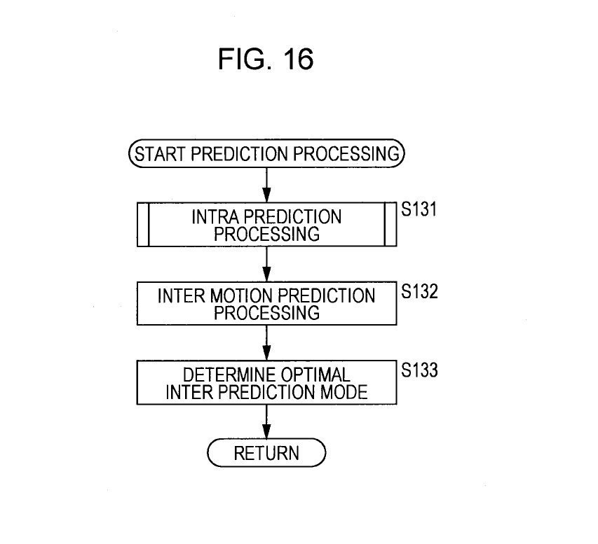

Next, the example of the flow of prediction processing executed in step S103 in FIG. 15 will be described with reference to the flowchart in FIG. 16.

In step S131, the intra prediction unit 114 performs intra prediction of the pixels of the block to be processed with all candidate intra prediction modes. Note that the intra prediction modes include both a mode for performing prediction using the reference image supplied from the frame memory 112 and a mode for performing prediction using the original image obtained from the screen rearranging buffer 102. Also, in the event that prediction is to be performed using a reference image supplied from the frame memory 112, pixels not subjected to deblocking filtering by the deblocking filter 111 are used as decoded pixels to be referenced.

In the event that the image to be processed that is supplied from the screen rearranging buffer 102 is an image for inter processing, the image to be reference is read out from the frame memory 112 and supplied to the motion prediction/compensation unit 115 via the selecting unit 113. Based on these images, in step S132 the motion prediction/compensation unit 115 performs inter motion prediction processing. That is to say, the motion prediction/compensation unit 115 references the image supplied from the frame memory 112 to perform motion prediction processing in all candidate inter prediction modes.

In step S133, the motion prediction/compensation unit 115 determines the prediction mode which yields the smallest value of the cost function values for the inter prediction modes calculated in step S132 to be the optimal inter prediction mode. The motion prediction compensation unit 115 then supplies the difference between the image for inter processing and the secondary difference information generated in the optimal inter prediction mode, and the cost function value of the optimal inter prediction mode, to the selecting unit 116.

### [Intra Prediction Processing]

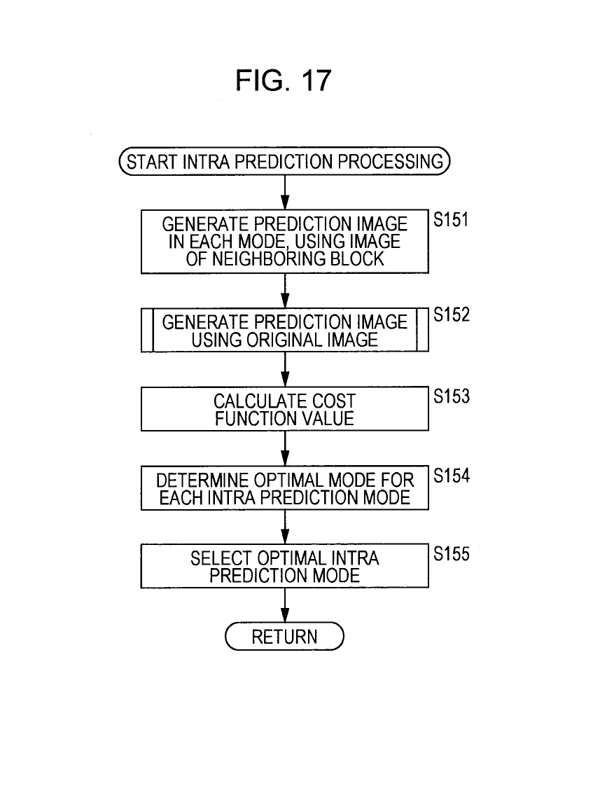

FIG. 17 is a flowchart describing an example of the flow of intra prediction processing executed in step S131 of FIG. 16.

Upon intra prediction processing being started, in step S151 the prediction image generating unit 131 uses pixels of a neighboring block of the reference image supplied from the frame memory 112 to generate a prediction image in each mode.

In step S152, the plane prediction image generating unit 132 uses the original image (original image) supplied from the screen rearranging buffer 102 to generate a prediction image.

In step S153, the cost function calculating unit 133 calculates a cost function value for each mode.

In step S154, the mode determining unit 134 determines the optimal mode of the intra processing modes, based on the cost function values of each mode calculated by the processing in step S153.

In step S155, the mode determining unit 134 selects the optimal intra prediction mode based on the cost function values of each mode calculated by the processing in step S153.

The mode determining unit 134 supplies the prediction image generated in the mode selected as the optimal intra prediction mode to the calculating unit 103 and computing unit 110. Also, the mode determining unit 134 supplies information indicating the selected prediction mode to the lossless encoding unit 106. Further, in the event of having selected a mode where the prediction image is generated using the original image, the mode determining unit 134 supplies encoded data of the plane parameters to the lossless encoding unit 106 as well.

Upon the processing of step S155 ending, the intra prediction unit 114 returns the processing to step S131 in FIG. 16, and executes the processing of step S132 and thereafter.

### [Prediction Image Generating Processing]

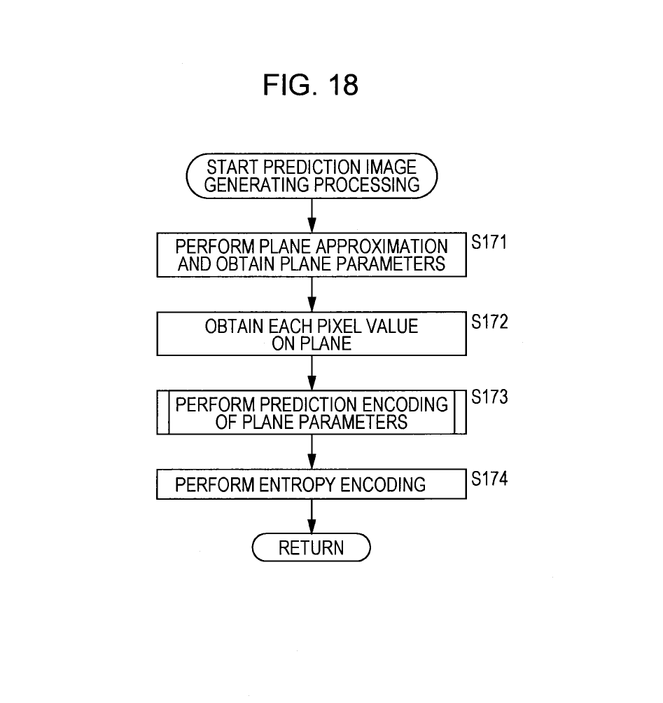

Next, an example of the flow of the prediction image generating processing executed in step S152 of FIG. 17 will be described with reference to the flowchart in FIG. 18.

Upon the prediction image generating processing being started, in step S171 the plane approximation unit 151 (FIG. 8) of the plane prediction image generating unit 132 performs plane approximation by solving the least squares as described above for example, using the original image read out from the screen rearranging buffer 102, and obtains plane parameters of a plane approximating the pixel values of the block to be processed.

In step S172, the plane generating unit 152 obtains the pixel values on the plane indicated by the plane parameters obtained by the processing in step S171, as prediction values. In step S173, the prediction encoding unit 153 performs prediction encoding of the plane parameters generated by the processing in step S171.

In step S174, the entropy encoding unit 154 performs entropy encoding of the prediction encoding results. Upon the entropy encoding ending, the plane prediction image generating unit 132 returns the processing to step S152 in FIG. 17, so as to execute the processing of step S153 and thereafter.

### [Prediction Encoding Processing]

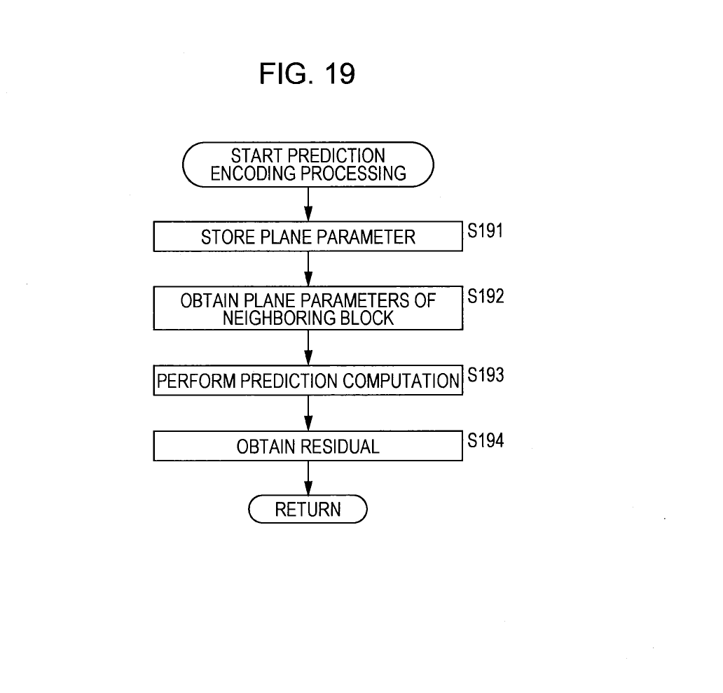

Next, an example of the flow of the prediction encoding processing executed in step S173 of FIG. 18 will be described with reference to the flowchart in FIG. 19.

Upon the prediction encoding processing being started, in step S191 the storage unit 171 (FIG. 12) of the prediction encoding unit 153 stores the plane parameters obtained by the processing in step S171 in FIG. 18.

In step S192, the neighboring block parameter obtaining unit 172 obtains the plane parameters of neighboring blocks stored in the storage unit 171. In step S193, the prediction computing unit 173 performs prediction computation such as described above using the plane parameters of neighboring blocks, and calculates prediction values of the plane parameters of the block to be processed.

In step S194, the encoding unit 174 obtains the difference (residual) between the prediction value calculated in step S193 and the plane parameters obtained by the processing in step S171 in FIG. 18, and supplies the residual to the entropy encoding unit 154 as prediction encoding results (encoded data).

Upon the processing of step S194 ending, the prediction encoding unit 153 returns the processing to step S173 in FIG. 18, so as to execute the processing of step S174 and thereafter.

As described above, the plane prediction image generating unit 132 performs plane approximation using the original image itself, so prediction precision can be improved over the case of the conventional mode 3 (Plane Prediction mode) of the intra prediction modes. Having provided such a mode as an intra prediction mode allows the encoding efficiency of the image encoding device 100 to be improved. Note that description has been made above regarding multiplexing the plane parameters in the header information of the encoded data as a method for transmitting the plane parameters, but the storage location of the plane parameters is optional. For example, the plane parameters may be stored in a parameter set (e.g., sequence or picture header or the like) such as SEI (Supplemental Enhancement Information) or the like. Also, the plane parameters may be transmitted from the image encoding device to the image decoding device separate from the encoded data (as a separate file).

### 2. Second Embodiment

### [Image Decoding Device]

Encoded data encoded by the image encoding device 100 described in the first embodiment is transmitted to an image decoding device corresponding to the image encoding device 100 via a predetermined transmission path, and is decoded.

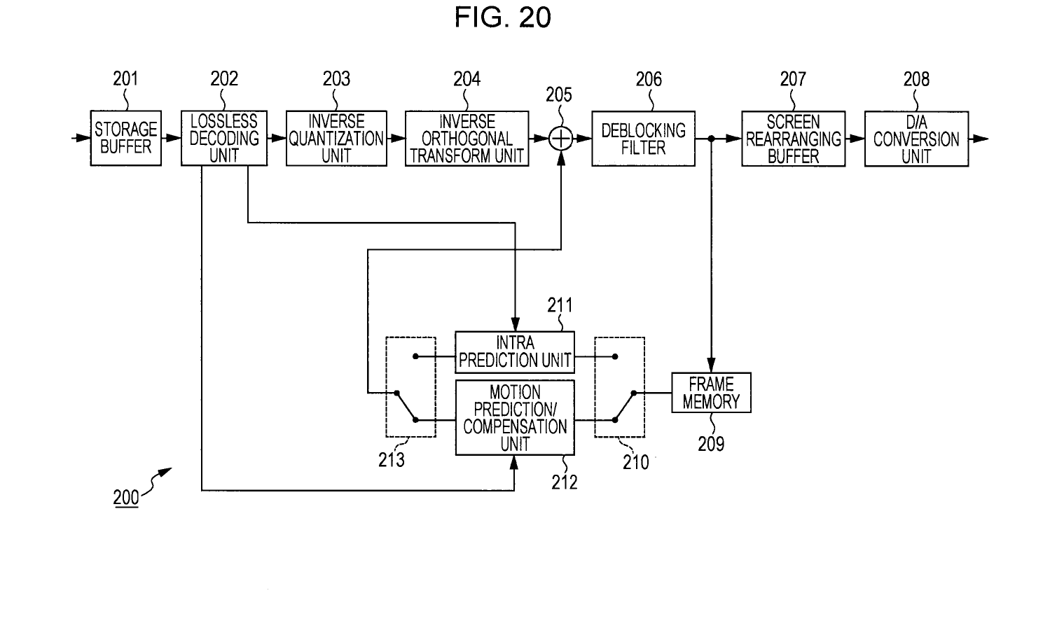

The following is a description of this image decoding device. FIG. 20 is a block diagram illustrating a primary configuration example of an image decoding device to which the present invention has been applied.

As shown in FIG. 20, an image decoding device 200 is configured of a storing buffer 201, a lossless decoding unit 202, an inverse quantization unit 203, an inverse orthogonal transform unit 204, a computing unit 205, a deblocking filter 206, a screen rearranging buffer 207 a D/A conversion unit 208, frame memory 209, a selecting unit 210, an intra prediction unit 211, a motion prediction/compensation unit 212, and a selecting unit 213.

The storing buffer 201 stores encoded data transmitted thereto. This encoded data has been encoded by the image encoding device 100. The lossless decoding unit 202 decodes encoded data read out from the storing buffer 201 at a predetermined timing with a format corresponding to the encoding format of the lossless encoding unit 106 in FIG. 1.

The inverse quantization unit 203 subjects the coefficient data obtained by being decoded by the lossless decoding unit 202 to inverse quantization using a format corresponding to the quantization format of the quantization unit 105 in FIG. 1. The inverse quantization unit 203 supplies the coefficient data subjected to inverse quantization to the inverse orthogonal transform unit 204. The inverse orthogonal transform unit 204 subjects the coefficient data to inverse orthogonal transform using a format corresponding to the orthogonal transform format of the orthogonal transform unit 104 in FIG. 1, and obtains decoded residual data corresponding to the residual data before having been subjected to orthogonal transform at the image encoding device 100.

The decoded residual data which has been obtained by inverse orthogonal transform is supplied to the computing unit 205. Also, prediction images are supplied to the computing unit 205 from the intra prediction unit 211 or motion prediction/compensation unit 212 via the selecting unit 213.

The computing unit 205 adds the decoded residual data and prediction image, and obtains decoded image data corresponding to the image data before the prediction image was subtracted by the calculating unit 103 of the image encoding device 100. The computing unit 205 supplies the decoded image data to the deblocking filter 206.

The deblocking filter 206 removes the block noise of the decoded image, then supplies to the frame memory 209 so as to be stored, and also supplies to the screen rearranging buffer 207.

The screen rearranging buffer 207 performs rearranging of images. That is to say, the order of frames rearranged for encoding by the screen rearranging buffer 102 in FIG. 1 is rearranged to the original display order. The D/A conversion unit 208 performs D/A conversion of the image supplied from the screen rearranging buffer 207, outputs to an unshown display, and displays.

The selecting unit 210 reads out the image for inter processing and the image for reference from the frame memory 209, and supplies to the motion prediction/compensation unit 212. Also, the selecting unit 210 reads out the image used for inter processing from the frame memory 209, and supplies to the intra prediction unit 211.

The intra prediction unit 211 is supplied as suitable with information indicating the intra prediction mode obtained by decoding the header information, information relating to plane parameters, and the like, from the lossless decoding unit 202. Based on this information, the intra prediction unit 211 generates a prediction image and supplies the generated prediction image to the selecting unit 213.

The motion prediction/compensation unit 212 receives the information obtained by decoding the header information (prediction mode information, motion vector information, reference frame information) from the lossless decoding unit 202. In the event that information indicating the inter prediction mode is supplied, the motion prediction/compensation unit 212 generates a prediction image based on the inter motion vector information from the lossless decoding unit 202, and supplies the generated prediction image to the selecting unit 213.

The selecting unit 213 selects the prediction image generated by the motion prediction/compensation unit 212 or intra prediction unit 211, and supplies to the computing unit 205.

### [Intra Prediction Unit]

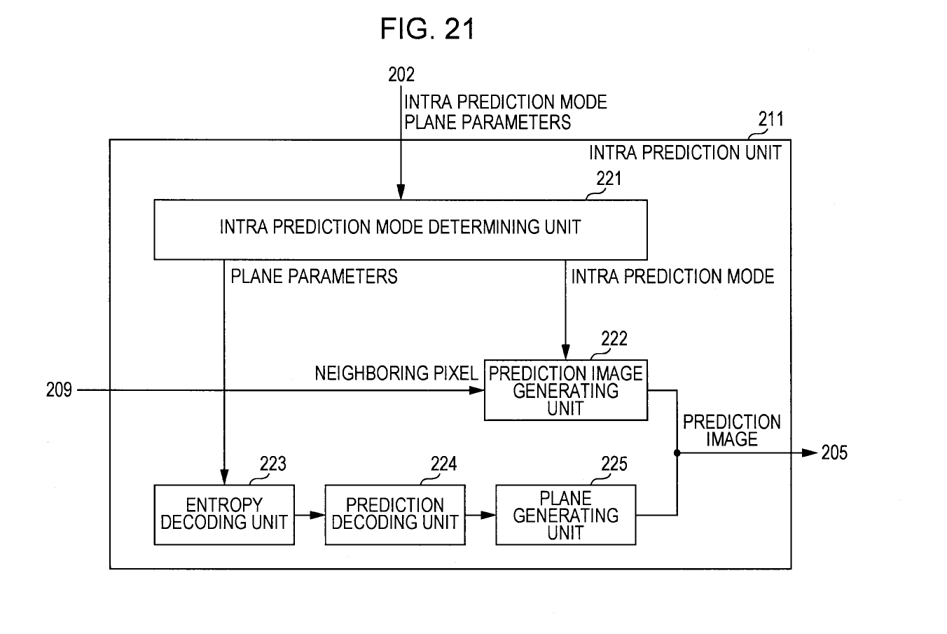

FIG. 21 is a block diagram illustrating a primary configuration example of the intra prediction unit 211 in FIG. 20.

As shown in FIG. 21, the intra prediction unit 211 has an intra prediction mode determining unit 221, a prediction image generating unit 222, an entropy decoding unit 223, a prediction decoding unit 224, and a plane generating unit 225.

The intra prediction mode determining unit 221 determines the intra prediction mode based on information supplied from the lossless decoding unit 202. In the case of a mode where a prediction image is generated using a reference image, the intra prediction mode determining unit 221 controls the prediction image generating unit 222 so as to generate a prediction unit. In the event of a mode where a prediction image is generated from plane parameters, the intra prediction mode determining unit 221 supplies the plane parameters supplied along with the information of the intra prediction mode to the entropy decoding unit 223.

The prediction image generating unit 222 obtains a reference image of a neighboring block from the frame memory 209, and generates a prediction image with the same method as that of the prediction image generating unit 131 (FIG. 3) of the image encoding device 100.

The plane parameters supplied to the entropy decoding unit 223 via the intra prediction mode determining unit 221 have been subjected to entropy processing at the entropy encoding unit 154 (FIG. 8). The plane parameters are subjected to entropy decoding with a method corresponding to that entropy encoding method. The entropy decoding unit 223 supplies the decoded plane parameters to the prediction decoding unit 224.

The plane parameters supplied from the entropy decoding unit 223 have been subjected to prediction encoding by the prediction encoding unit 153 (FIG. 8). The prediction decoding unit 224 subjects the plane parameters to prediction decoding with a method corresponding to that prediction encoding method. The prediction decoding unit 224 supplies the decoded plane parameters to the plane generating unit 225.

The plane generating unit 225 generates a prediction image in which an approximated plane indicated by the plane parameters (a, b, c) is represented by pixel values, with the same method as that of the plane generating unit 152 (FIG. 8). The plane generating unit 225 supplies the generated prediction image to the computing unit 205.

### [Prediction Decoding Image]

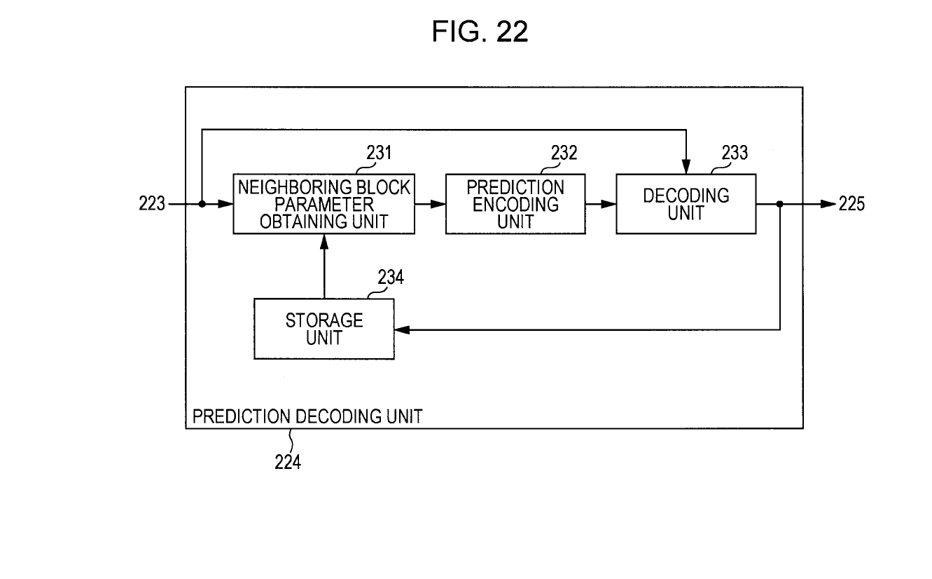

FIG. 22 is a block diagram illustrating a primary configuration example of the prediction decoding unit 224 in FIG. 21.

As shown in FIG. 22, the prediction decoding unit 224 has a neighboring block parameter obtaining unit 231, a prediction computing unit 232, a decoding unit 233, and a storage unit 234.

Upon being supplied with plane parameters of the block to be processed subjected to prediction encoding, the neighboring block parameter obtaining unit 231 obtains plane parameters of a block neighboring the block to be processed (neighboring block) stored in the storage unit 234. The neighboring block parameter obtaining unit 231 supplies the obtained plane parameters to the prediction computing unit 232.

The prediction computing unit 232 performs prediction processing the same as with the prediction computing unit 173, and calculates prediction values of plane parameters of the block to be processed, from the plane parameters of the neighboring block supplied thereto. The prediction computing unit 232 supplies the calculated prediction values to the decoding unit 233.

The entropy decoding unit 223 adds the prediction values supplied from the prediction computing unit 232 to the plane parameters subjected to prediction encoding that are supplied from the entropy decoding unit 223, thereby decoding the plane parameters. The decoding unit 233 supplies the decoding results (decoded plane parameters) to the plane generating unit 225. Also, the decoding unit 233 supplies the decoded plane parameters to the storage unit 234 so as to be stored.

### [Decoding Processing]

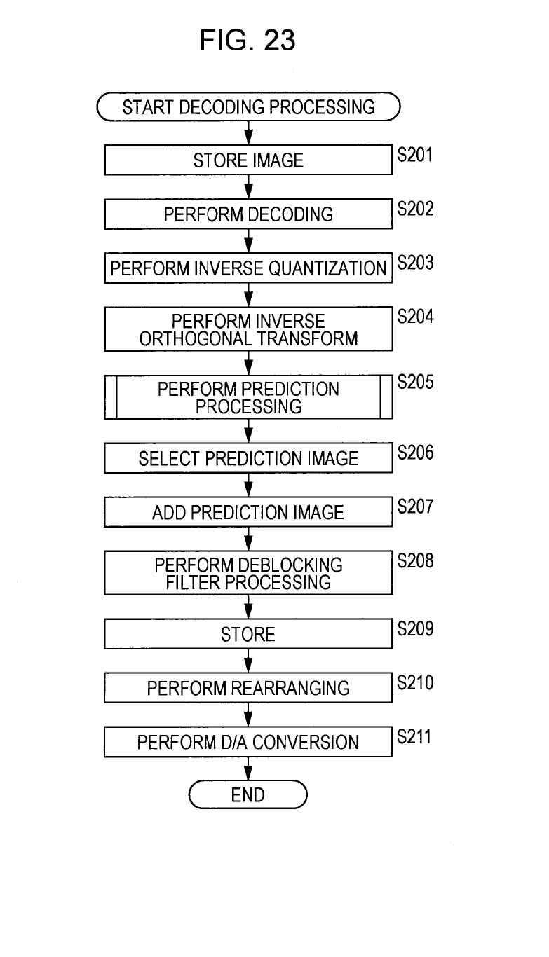

Next, the flows of each processing executed by the image decoding device 200 will be described. First, an example of the flow of decoding processing will be described with reference to the flowchart in FIG. 23.

Upon the decoding processing being started, in step S201, the storing buffer 201 stores the transmitted image. In step S202, the lossless decoding unit 202 decodes the compressed image supplied from the storing buffer 201. Specifically, the I picture, P picture, and B picture encoded by the lossless encoding unit 106 in FIG. 1 are decoded.

At this time, the motion vector information, reference frame information, prediction mode information (intra prediction mode or inter prediction mode), flag information, plane parameters, and so forth, are also decoded.

Specifically, in the event that the prediction mode information is intra prediction mode information, the prediction mode information is supplied to the intra prediction unit 211. In the event that the prediction mode information is inter prediction mode information, motion vector information and reference frame information corresponding to the prediction mode information are supplied to the motion prediction/compensation unit 212.

Also, in the event that plane parameters exist, the plane parameters are supplied to the intra prediction unit 211.

In step S203, the inverse quantization unit 203 inversely quantizes the transform coefficient decoded by the lossless decoding unit 202 using a property corresponding to the property of the quantization unit 105 in FIG. 1. In step S204, the inverse orthogonal transform unit 204 subjects the transform coefficient inversely quantized by the inverse quantization unit 203 to inverse orthogonal transform using a property corresponding to the property of the orthogonal transform unit 104 in FIG. 1. This means that difference information corresponding to the input of the orthogonal transform unit 104 in FIG. 1 (the output of the computing unit 103) has been decoded.

In step S205, the intra prediction unit 211 or motion prediction/compensation unit 212 performs the respective image prediction processing in accordance with the prediction mode information supplied from the lossless decoding unit 202.

That is to say, in the event that intra prediction mode information is supplied from the lossless decoding unit 202, the intra prediction unit 211 performs intra prediction mode intra prediction processing. Also, in the event that plane parameters are supplied from the lossless decoding unit 202 as well, the intra prediction unit 211 performs intra prediction processing using those plane parameters.

In the event that inter prediction mode information is supplied from the lossless decoding unit 202, the motion prediction/compensation unit 212 performs inter prediction mode motion prediction processing.

In step S206, the selecting unit 213 selects a prediction image. That is to say, the selecting unit 213 is supplied with a prediction image generated by the intra prediction unit 211, or, a prediction image generated by the motion prediction/compensation unit 212. The selecting unit 213 selects one of these. The selected prediction image is supplied to the computing unit 205.

In step S207, the computing unit 205 adds the prediction image selected in the processing in step S206 to the difference information obtained by the processing in step S204. Thus, the original image is decoded.

In step S208, the deblocking filter 206 subjects the decoded image output from the computing unit 205 to filtering. Thus, block distortion is removed.

In step S209, the frame memory 209 stores the decoded image subjected to filtering.

In step S210, the screen rearranging buffer 207 performs rearranging of the decoded image data. Specifically, the sequence of frames rearranged for encoding by the screen rearranging buffer 102 (FIG. 1) of the image encoding device 100 is rearranged in the original display sequence.

In step S211, the D/A conversion unit 208 converts the decoded image data from the screen rearranging buffer 207 regarding which the frames have been rearranged, from digital to analog. This image is output to an unshown display, and the image is displayed.

### [Prediction Processing]

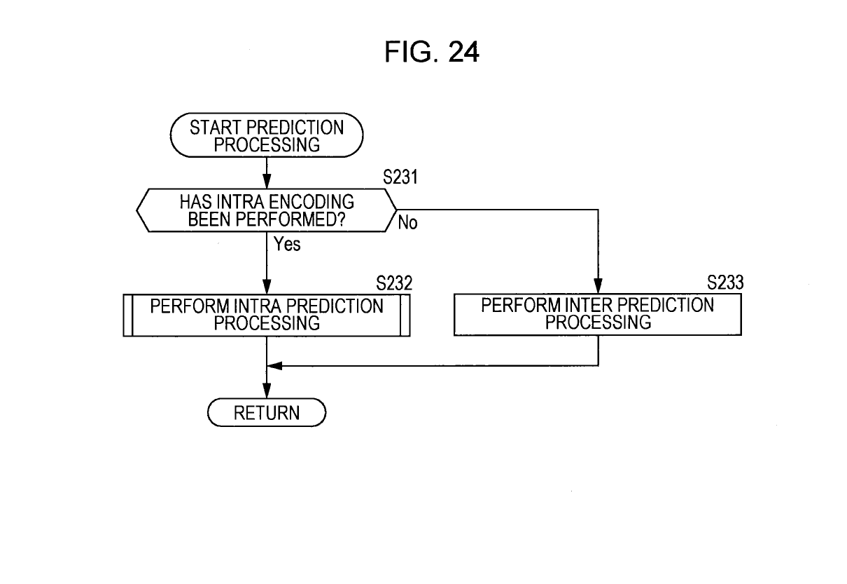

Next, the prediction processing in step S205 in FIG. 23 will be described with reference to the flowchart in FIG. 24.

Upon prediction processing being started, in step S171, the lossless decoding unit 202 determines whether or not this has been subjected to intra encoding, based on the intra prediction mode information. In the event that determination is made that intra encoding has been performed, the lossless decoding unit 202 supplies the intra prediction mode information to the intra prediction unit 211, and the processing advances to step S232. Note that in the event that plane parameters exist, the lossless decoding unit 202 supplies the plane parameters to the intra prediction unit 211 as well.

In step S232, the intra prediction unit 211 performs intra prediction processing. Upon the intra prediction processing ending, the intra prediction unit 211 returns the processing to step S205 in FIG. 23, and processing of step S206 and thereafter is executed.

Also, in the event that determination is made in step S231 that inter encoding has been performed, the lossless decoding unit 202 supplies the inter prediction mode information to the motion prediction/compensation unit 212, and the processing advances to step S233.

In step S233, the motion prediction/compensation unit 212 performs inter motion prediction/compensation processing. Upon the inter motion prediction/compensation processing ending, the motion prediction/compensation unit 212 returns the flow to step S205 in FIG. 23, and processing of step S206 and thereafter is executed.

### [Intra Prediction Processing]

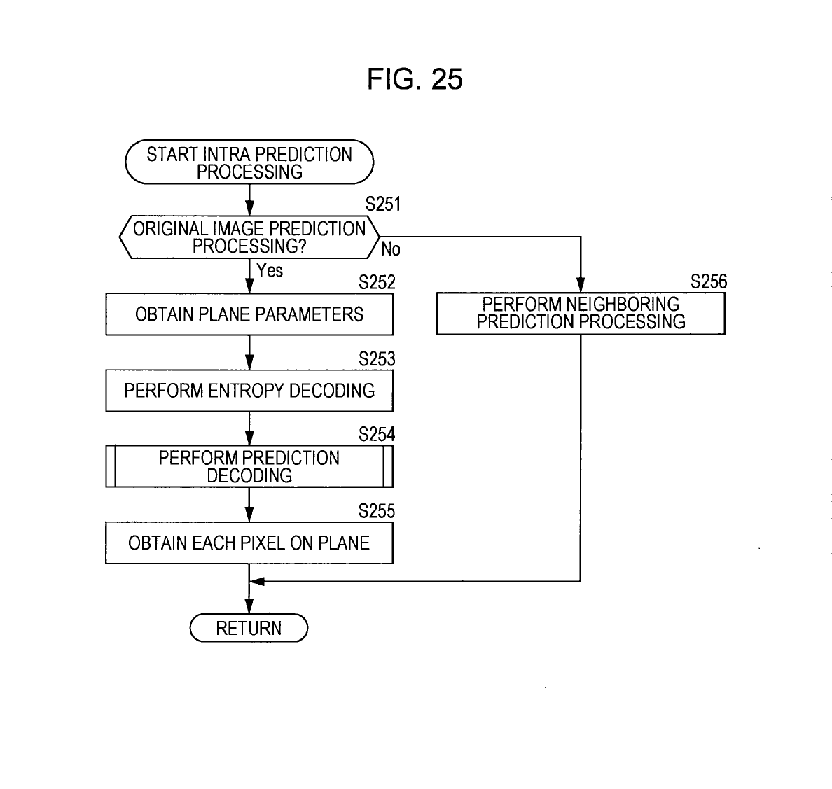

Next, an example of the flow of intra prediction processing executed in step S232 in FIG. 24 will be described with reference to the flowchart in FIG. 25.

Upon the intra prediction processing being started, in step S251 the intra prediction mode determining unit 221 determines whether or not this is original image prediction processing where prediction processing is performed from plane parameters generated from an original image (original image) supplied from the image encoding device 100. In the event that determination is made based on the intra prediction mode information supplied from the lossless decoding unit 202 that this is original image processing, the intra prediction mode determining unit 221 advances the processing to step S252.

In step S252, the intra prediction mode determining unit 221 obtains plane parameters from the lossless decoding unit 202.

In step S253 the entropy decoding unit 223 performs entropy decoding of the plane parameters.

In step S254, the prediction decoding unit 224 performs decoding processing of the plane parameters subjected to entropy decoding.

In step S255, the plane generating unit 225 obtains the pixel values on the plane which the decoded plane parameters indicate.

Upon the processing of step S255 ending, the intra prediction unit 211 returns the flow to step S232 in FIG. 24, and subsequent processing is repeated.

Also, in the event that determination is made in step S251 that this is not original image prediction processing, the intra prediction mode determining unit 221 advances the processing to step S256.

In step S256, the prediction image generating unit 222 obtains a reference image from the frame memory 209, and performs neighboring prediction processing in which prediction of the block to be processed is performed from neighboring pixels included in the reference image. Upon the processing of step S256 ending, the intra prediction unit 211 returns the processing to step S232 in FIG. 24, and subsequent processing is repeated.

### [Prediction Decoding Processing]

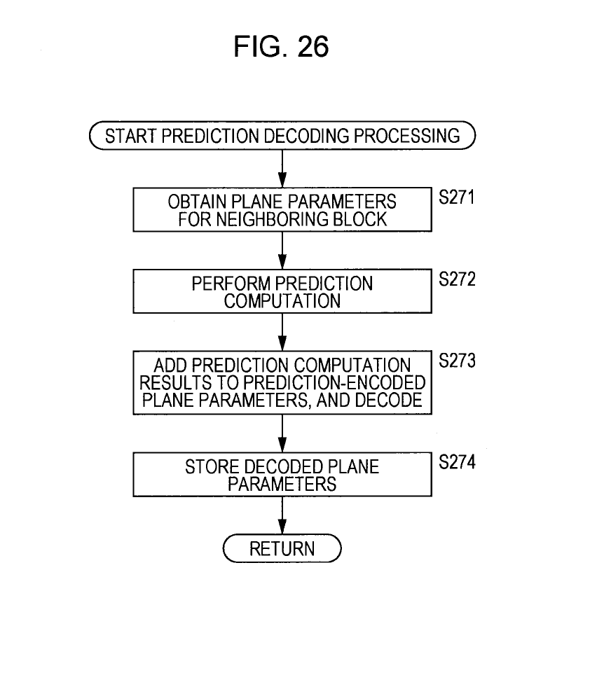

Next, an example of the flow of prediction decoding processing executed in step S254 in FIG. 25 will be described with reference to the flowchart in FIG. 26.

Upon the prediction decoding processing being started, in step S271 the neighboring block parameter obtaining unit 231 obtains plane parameters from neighboring blocks from the storage unit 234.

In step S272, the prediction computing unit 232 performs prediction computation using the plane parameters of the neighboring blocks that have been obtained, and predicts the plane parameters of the block to be processed.

In step S273, the entropy decoding unit 223 adds the prediction computation results to the plane parameters subjected to prediction encoding, so as to decode.

In step S274, the storage unit 234 stores the decoded plane parameters.

As described above, the intra prediction unit 211 generates a prediction image using the plane parameters supplied from the image encoding device 100, so the image decoding device 200 can decode the encoded data in which the image encoding device 100 has performed encoding using the original image itself in intra prediction mode. That is to say, the image encoding device 100 can decode the encoded data encoded in the intra prediction mode with high prediction precision.

Note that the prediction decoding unit 224 can decode the plane parameters subjected to prediction encoding. That is to say, the image decoding device 200 can perform decoding processing using plane parameters with reduced data amount.

Also, the entropy decoding unit 223 can decode the plane parameters subjected to entropy encoding. That is to say, the image decoding device 200 can perform decoding processing using plane parameters with reduced data amount.

That is to say, the image decoding device 200 can further improve encoding efficiency.

### 3. Third Embodiment

### [Prediction Encoding Unit]

As for a prediction encoding method for plane parameters, a method has been described with the first embodiment and second embodiment where plane parameters of neighboring blocks already calculated are used to calculate prediction values of the plane parameters of the block to be processed, and the prediction values are subtracted from the actual plane parameters.

However, the prediction encoding method for the plane parameters may be other than this. For example, plane parameters of the block to be processed, calculated by mode 3 (Plane Prediction mode) of the intra 16×16 prediction mode, may be used as prediction values.

These plane parameters are already calculated as mode 3 of the intra 16×16 prediction mode (hereinafter called plane mode), so by using these values, there is no need to calculate the prediction values again, and load regarding prediction encoding of plane parameters can be reduced.

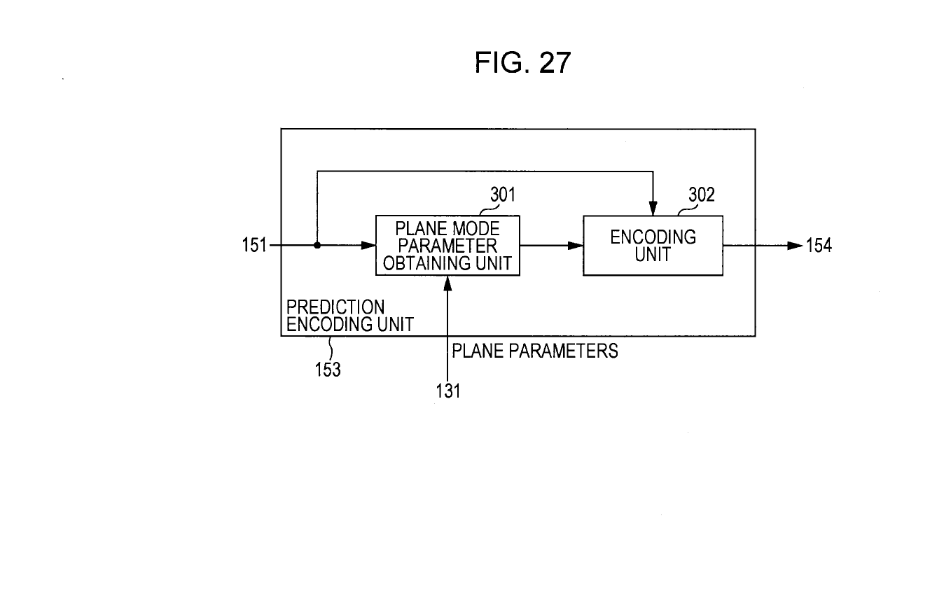

FIG. 27 is a block diagram illustrating a primary configuration example of a prediction encoding unit 153 of the image encoding device 100 in this case.

As shown in FIG. 27, in this case, the prediction encoding unit 153 has a plane mode plane parameter obtaining unit 301 and an encoding unit 302.

The plane mode plane parameter obtaining unit 301 obtains plane parameters of the block to be processed from the plane approximation unit 151, and thereupon obtains the plane parameters of the block to be processed generated by intra prediction in the pane mode by the prediction image generating unit 131. The plane mode plane parameter obtaining unit 301 supplies the obtained plane mode plane parameters to the encoding unit 302.

The encoding unit 302 takes the plane mode plane parameters supplied from the plane mode plane parameter obtaining unit 301 as prediction values, and encodes the plane parameters by subtracting these prediction values from the plane parameters of the block to be processed which the plane approximation unit 151 has generated.

That is to say, the encoding unit 302 subtracts from the plane parameters a, b, and c, the respective prediction values. The encoding unit 302 supplies the prediction encoding results to the entropy encoding unit 154.

### [Prediction Encoding Processing]

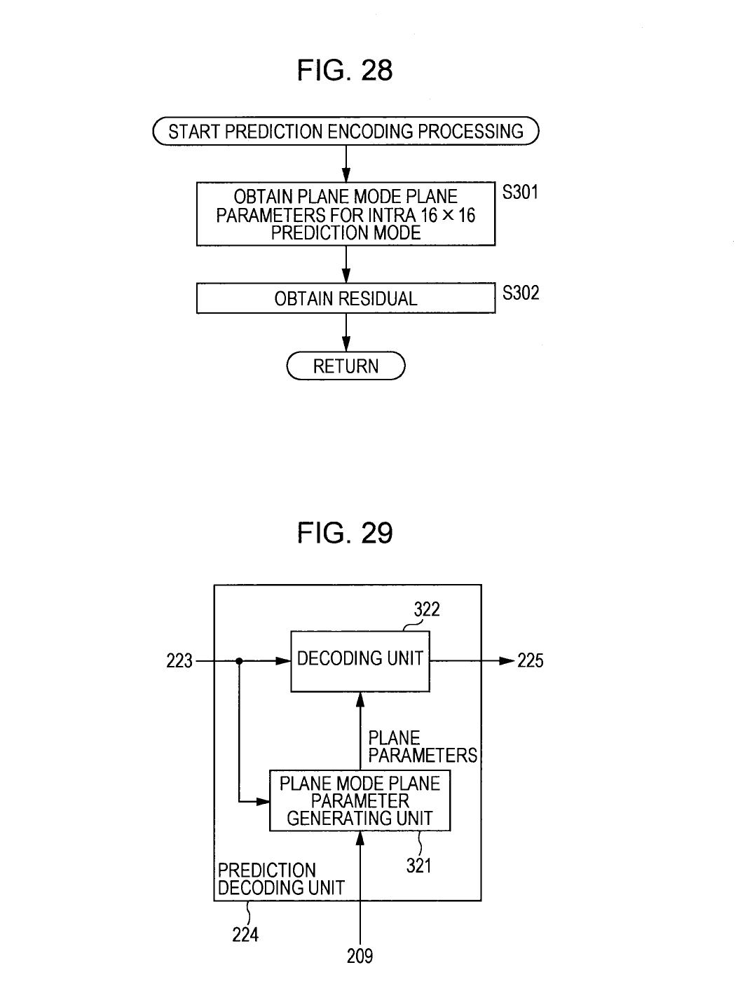

Next, an example of the flow of prediction encoding processing executed by such a prediction encoding unit 153 will be described with reference to the flowchart in FIG. 28.

Upon the prediction encoding processing being started, in step S301 the plane mode plane parameter obtaining unit 301 obtains plane parameters of the plane mode of the intra 16×16 prediction modes.

In step S302, the encoding unit 302 takes the plane parameters of the plane mode of the intra 16×16 prediction modes as prediction values, and obtains the residual between the plane parameters obtained by the plane approximation unit 151 and the prediction values thereof as prediction encoding results.

Upon the processing of step S302 ending, the prediction encoding unit 153 returns the flow to step S173 in FIG. 18, so as to execute the processing of step S174 and thereafter.

Thus, the image encoding device 100 can reduce the data amount of plane parameters, and further improve encoding efficiency.

### 4. Fourth Embodiment

### [Prediction Decoding Unit]

Next, the image decoding device 200, which decodes encoded data generated by the image data being encoded by the image encoding device 100 described in the third embodiment, will be described.

FIG. 29 is a block diagram illustrating a primary configuration example of the prediction decoding unit 224 of the image decoding device 200 in this case.

As shown in FIG. 29, in this case, the prediction decoding unit 224 has a plane mode plane parameter generating unit 321 and a decoding unit 322.

Upon obtaining plane parameters of the block to be processed subjected to entropy encoding by the entropy decoding unit 223, the plane mode plane parameter generating unit 321 uses the reference image of the neighboring blocks supplied from the frame memory 209 to generate the plane parameters of the plane mode of the intra 16×16 prediction modes.

The plane mode plane parameter generating unit 321 generates plane parameters with the same method as that of the case of the prediction image generating unit 131 of the image-encoding device 100 generating the plane parameters of the plane mode of the intra 16×16 prediction modes. The plane mode plane parameter generating unit 321 supplies the generated plane parameters to the decoding unit 322.

The decoding unit 322 takes the plane parameters of the plane mode of the intra 16×16 prediction modes generated by the plane mode plane parameter generating unit 321 as prediction values. The decoding unit 322 adds these prediction values to the prediction encoded plane parameters of the block to be processed, that have bee supplied from the entropy decoding unit 223.

That is to say, the decoding unit 322 adds to the plane parameters a, b, and c, the respective prediction values. The decoding unit 322 supplies the prediction decoding results to the plane generating unit 225.

### [Prediction Decoding Processing]

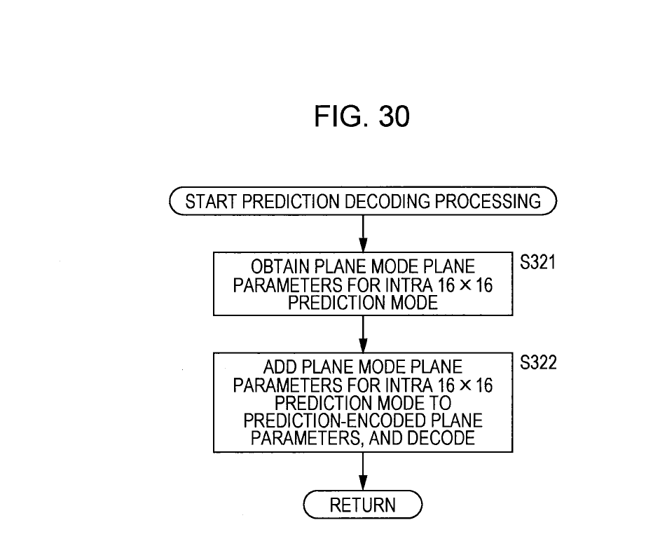

An example of the flow of prediction decoding processing executed in step S254 in FIG. 25 in this case will be described with reference to the flowchart in FIG. 30.

Upon the prediction decoding processing being started, in step S321 the plane mode plane parameter generating unit 321 obtains the plane parameters in the plane mode of the intra 16×16 prediction modes.

In step S322, the decoding unit 322 adds the plane parameters of the plane mode of the intra 16×16 prediction modes calculated by the processing in step S321 to the prediction decoded plane parameters, thereby decoding.

Upon the processing in step S322 ending, the prediction decoding unit 224 returns the processing to step S254 in FIG. 25, so as to execute the processing of step S255 and thereafter.

Thus, the prediction decoding unit 224 can decode the plane parameters which the prediction encoding unit 153 of the image encoding device 100 has subjected to prediction encoding.

That is to say, the image decoding device 200 can reduce the data amount of plane parameters, and can further improve encoding efficiency.

### 5. Fifth Embodiment

### [Transform Processing]

Note that while description has been made above that the plane parameters are subjected to prediction encoding, the plane parameters may be subjected to orthogonal transform.

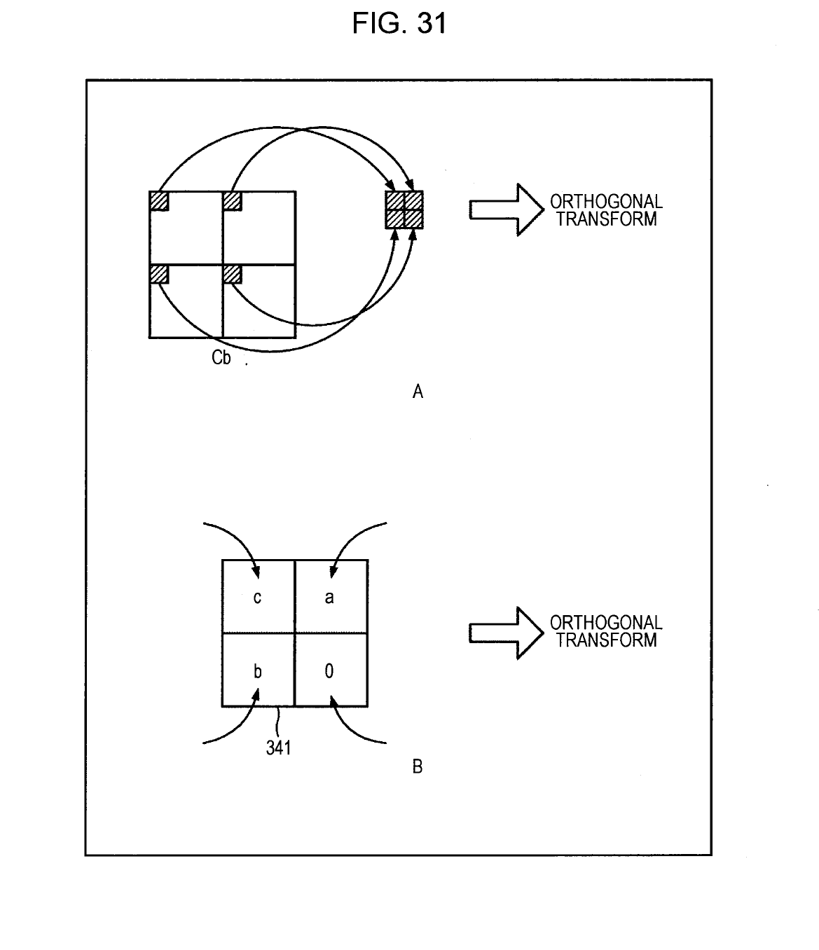

FIG. 31 is a diagram describing an example of how transform processing works. For example, as illustrated in A in FIG. 31, in the case of intra prediction mode, the image encoding device 100 extracts the CD component of 2×2 adjacent blocks subjected to orthogonal transform with regard to color difference signals, and further subjects these to orthogonal transform as one block of 2×2.

Using this system, the image encoding device 100 generates a 2×2 block 341 using the plane parameters a, b, and c, and performs orthogonal transform thereof. The 2×2 block 341 has c for the upper left value, a for the upper right value, b for the lower left value, and 0 for the lower right value.

By thus generating the 2×2 block 341 using the plane parameters and performing orthogonal transform of the block 341, the plane parameters can be subjected to entropy encoding more efficiently. That is to say, the image encoding device 100 can further improve encoding efficiency.

### [Plane Prediction Image Generating Unit]

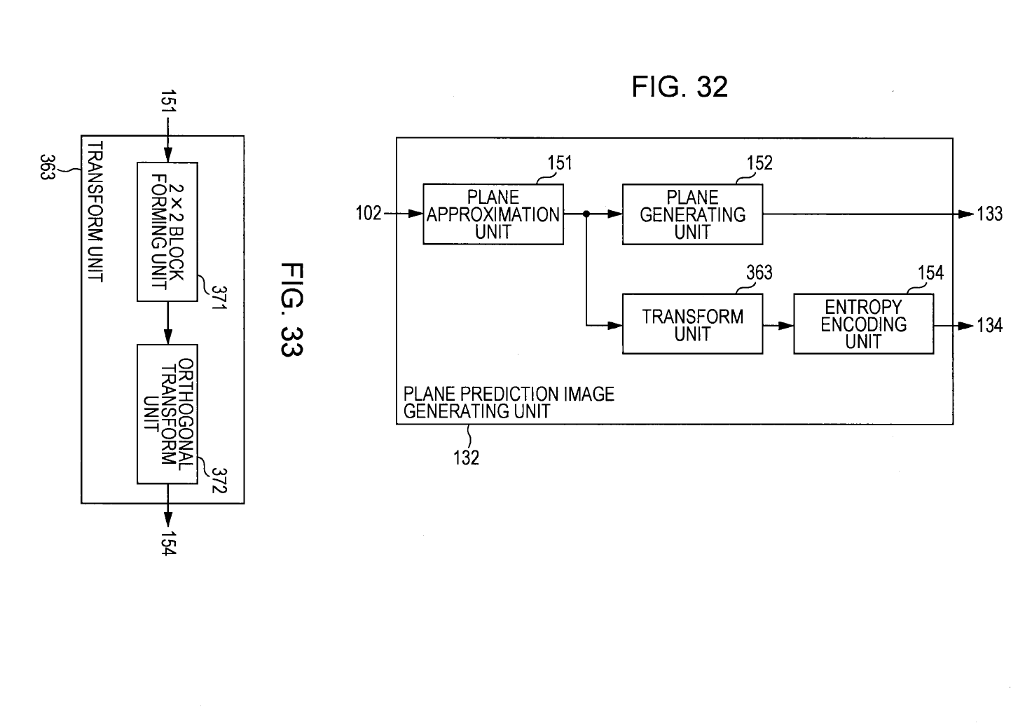

FIG. 32 is a block diagram illustrating a configuration example of the plane prediction image generating unit 132 in this case. In this case as well, the plane prediction image generating unit 132 basically has the same configuration as with the case described with reference to FIG. 8.

However, in this case, a transform unit 363 is had instead of the prediction encoding unit 153.

As described with reference to B in FIG. 31, the transform unit 363 generates a 2×2 block using the plane parameters generated by the plane approximation unit 151, and performs orthogonal transform thereof. The transform unit 363 supplies the coefficient data obtained by the orthogonal transform to the entropy encoding unit 154.

The entropy encoding unit 154 performs entropy encoding of the coefficient data supplied from the transform unit 363.

### [Transform Unit]

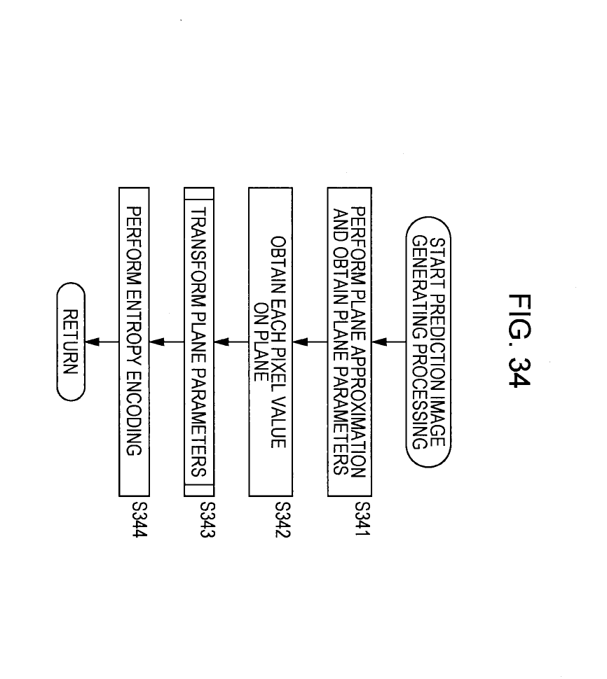

FIG. 33 is a block diagram illustrating a primary configuration example of the transform unit 363.

As shown in FIG. 33, the transform unit 363 has a 2×2 block forming unit 371 and an orthogonal transform unit 372.

The 2×2 block forming unit 371 adds the value “0” to the plane parameters a, b, c supplied from the plane approximation unit 151, and forms a 2×2 block such as shown in B in FIG. 31. The 2×2 block forming unit 371 supplies this 2×2 block to the orthogonal transform unit 372.

The orthogonal transform unit 372 performs orthogonal transform of the 2×2 block supplied from the 2×2 block forming unit 371. The orthogonal transform unit 372 supplies the generated coefficient data to the entropy encoding unit 154.

### [Prediction Image Generating Processing]

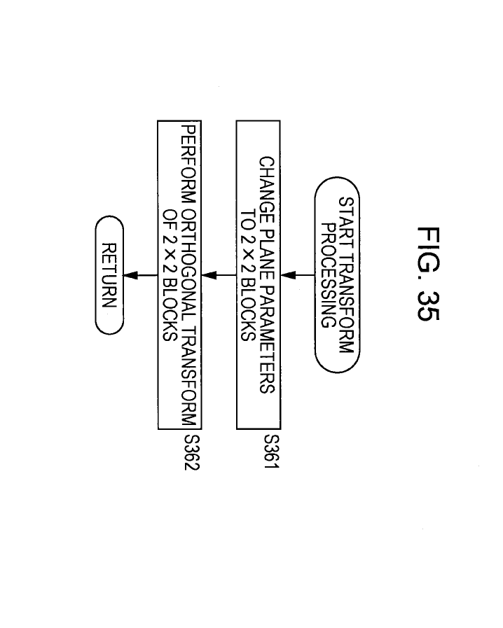

Another example of the flow of prediction image generating processing executed by the plane prediction image generating unit 132 in FIG. 32 will be described with reference to the flowchart in FIG. 34. This processing corresponds to the prediction image generating processing described with reference to the flowchart in FIG. 18.

Upon the prediction image generating processing being started, in step S341 the plane approximation unit 151 performs plane approximation, and obtains plane parameters. In step S342, the plane generating unit 152 obtains the pixel values on the plane indicated by the plane parameters.

In step S343, the transform unit 363 performs orthogonal transform of the plane parameters obtained by the processing in step S341 as shown in B in FIG. 31. In step S344, the entropy encoding unit 154 performs entropy encoding of the plane parameters subjected to orthogonal transform in step S343.

Upon the entropy encoding unit 154 ending, the plane prediction image generating unit 132 ends prediction image generating processing and returns the processing to FIG. 17, so as to execute the processing of step S153 and thereafter.

### [Transform Processing]

Next, an example of the flow of transform processing executed in step S343 of FIG. 34 will be described with reference to the flowchart in FIG. 35.

Upon the transform processing being started, in step S361 the 2×2 block forming unit 371 adds the value “0” to the plane parameters, so as to obtain a 2×2 block as shown in B in FIG. 31.

In step S362, the orthogonal transform unit 372 performs orthogonal transform of the 2×2 block.

Upon the transform processing ending, the transform unit 363 returns the processing to FIG. 34, so as to execute the processing of step S345 and thereafter.

As described above, by forming 2×2 blocks using the values of the plane parameters and performing orthogonal transform thereof, the plane prediction image generating unit 132 can reduce the data amount of the plane parameters. That is to say, the image encoding device 100 can further improve encoding efficiency.

### 6. Sixth Embodiment

### [Intra Prediction Unit]

Next, description will be made regarding the image decoding device 200 which decodes encoded data generated by image data being encoded by the image encoding device 100 described in the fifth embodiment.

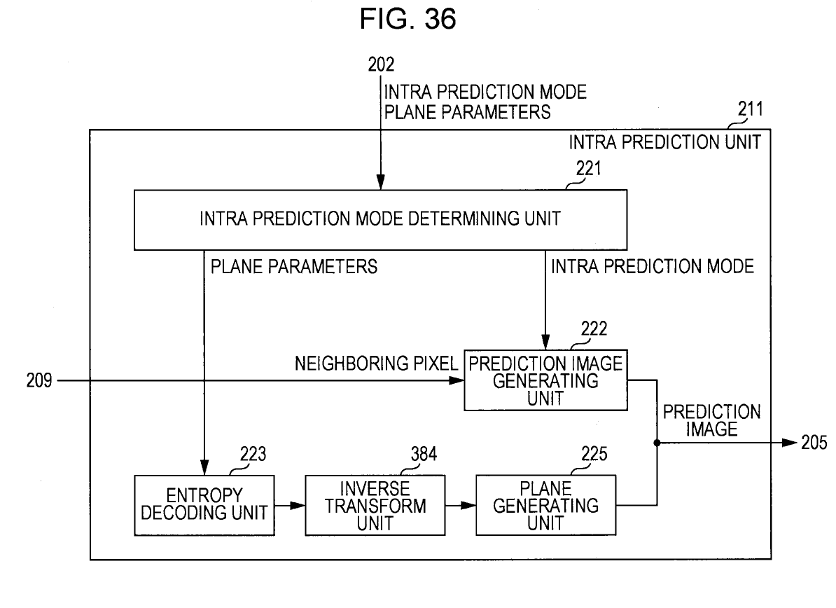

FIG. 36 is a block diagram illustrating a primary configuration example of the intra prediction unit 211 of the image decoding device 200 in this case.

As shown in FIG. 36, the intra prediction unit 211 in this case has basically the same configuration as with the case in FIG. 21, but has an inverse transform unit 384 instead of the prediction decoding unit 224.

The data obtained by being subjected to entropy decoding by the entropy decoding unit 223 is coefficient data subjected to orthogonal transform at the transform unit 363 (FIG. 32) of the image encoding device 100.

The inverse transform unit 384 performs inverse orthogonal transform of the coefficient data supplied from the entropy decoding unit 223 by a method corresponding to the transform unit 363. The inverse transform unit 384 supplies the plane parameters obtained by the inverse orthogonal transform to the plane generating unit 225.

### [Inverse Transform Unit]

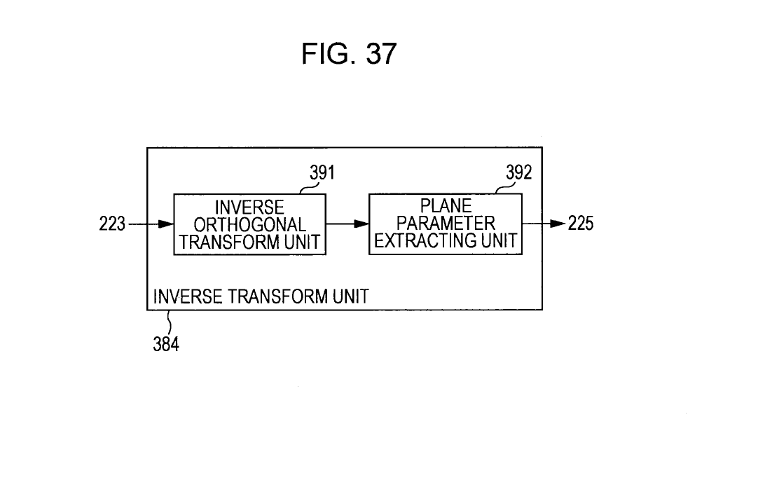

FIG. 37 is a block diagram illustrating a primary configuration example of the inverse transform unit 384.

As shown in FIG. 37, the inverse transform unit 384 has an inverse orthogonal transform unit 391 and plane parameter extracting unit 392.

The inverse orthogonal transform unit 391 performs inverse orthogonal transform of the coefficient data supplied from the entropy decoding unit 223 with a method corresponding to the transform unit 363. The inverse orthogonal transform unit 391 supplies the 2×2 block subjected to inverse orthogonal transform to the plane parameter extracting unit 392.

The plane parameter extracting unit 392 extracts the plane parameters a, b, c from the 2×2 block, and supplies these to the plane generating unit 225.

### [Intra Prediction Processing]

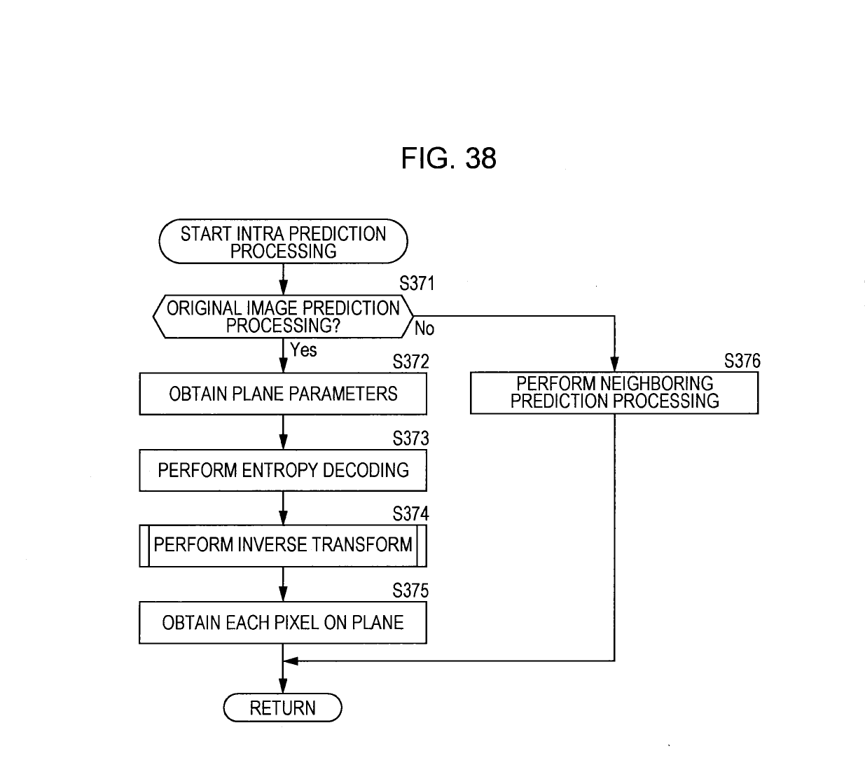

Another example of intra prediction processing executed by the intra prediction unit 211 in FIG. 36 will be described with reference to the flowchart in FIG. 38. This processing corresponds to the intra prediction processing described with reference to the flowchart in FIG. 25.

This intra prediction processing is performed basically in the same way as with the case described with reference to the flowchart in FIG. 25. That is to say, each processing of step S371 through step S373 and step S375 and step S376, is performed in the same way as each processing of step S251 through step S253 and step S255 and step S256 in FIG. 25.

In step S374, the inverse transform unit 384 performs inverse orthogonal transform of the 2×2 block subjected to entropy encoding, and obtains the values of the plane parameters.

### [Inverse Transform Processing]

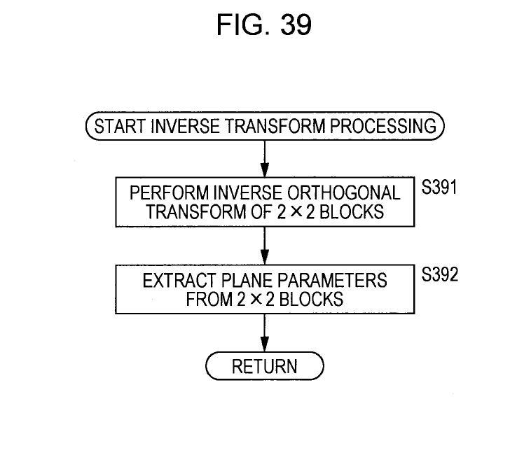

Next, an example of the flow of inverse transform processing executed in step S374 of FIG. 38 will be described with reference to the flowchart in FIG. 39.

Upon inverse transform processing being started, in step S391 the inverse orthogonal transform unit 391 performs inverse orthogonal transform of the 2×2 block. In step S392, the plane parameter extracting unit 392 extracts the plane parameters a, b, c from the 2×2 block.

Upon the plane parameters being extracted, the inverse transform unit 384 ends the inverse transform processing, returns the processing to FIG. 38, and advances to step S375.

AS described above, the inverse transform unit 384 can perform inverse orthogonal transform of the 2×2 block subjected to orthogonal transform, and extract plane parameters. Accordingly, the intra prediction unit 211 can reduce the data amount of the plane parameters. That is to say, the image decoding device 200 can further improve encoding efficiency.

Note that description has been made above that the image encoding device 100 includes the plane parameters is the encoded data in which image data (residual information) has been encoded. However, not restricted to this, the image encoding device 100 may supply the plane parameters to the image decoding device 200 separately from the encoded data.

### [Macroblocks]

While macroblocks of 16×16 or smaller have been described above, the size of the macroblocks may be greater than 16×16.

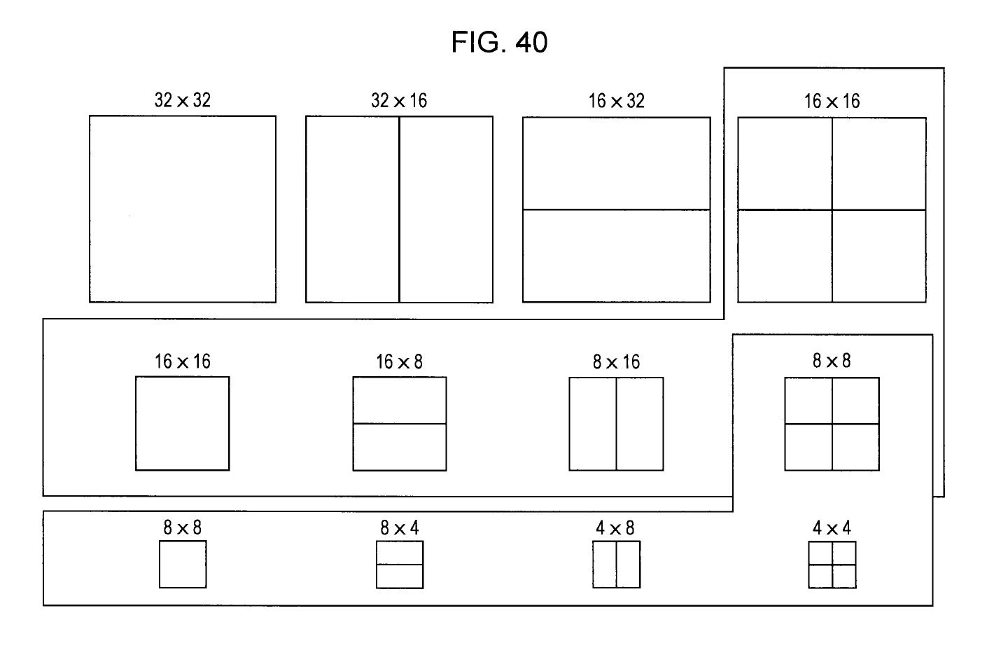

The present invention can be applied to various sizes of macroblocks such as shown in FIG. 40, for example. For example, the present invention can be applied to not only macroblocks such as normal 16×16 pixels, but also to extended macroblocks such as 32×32 pixels (extended macroblock).

In FIG. 40, macroblocks made up of 32×32 pixels divided into blocks (partitions) of 32×32 pixels, 32×16 pixels, 16×32 pixels, and 16×16 pixels are shown from the left in order on the upper tier. Blocks made up of 16×16 pixels divided into blocks of 16×16 pixels, 16×8 pixels, 8×16 pixels, and 8×8 pixels are shown from the left in order on the middle tier. Also, blocks made up of 8×8 pixels divided into blocks of 8×8 pixels, 8×4 pixels, 4×8 pixels, and 4×4 pixels are shown from the left in order on the lower tier.

In other words, the macroblocks of 32×32 pixels may be processed with blocks of 32×32 pixels, 32×16 pixels, 16×32 pixels, and 16×16 pixels shown on the upper tier.

Also, the blocks of 16×16 pixels shown on the right side on the upper tier may be processed with blocks of 16×16 pixels, 16×8 pixels, 8×16 pixels, and 8×8 pixels shown on the middle tier in the same way as with the H.264/AVC format.

The block of 8×8 pixels shown on the right side on the middle tier may be processed with blocks of 8×8 pixels, 8×4 pixels, 4×8 pixels, and 4×4 pixels shown on the lower tier in the same way as with the H.264/AVC format.

These blocks can be classified into the following three hierarchical levels. That is, we will refer to the blocks of 32×32 pixels, 32×16 pixels, 16×32 pixels, and 16×16 pixels, shown on the upper tier in FIG. 40, as a first hierarchical level. We will refer to the blocks of 16×16 pixels, shown to the right of the upper tier, and the blocks of 16×16 pixels, 16×8 pixels, 8×16 pixels, and 8×8 pixels shown in the middle tier, as a second hierarchical level. We will refer to the blocks of 8×8 pixels, shown to the right of the middle tier, and the blocks of 8×8 pixels, 8×4 pixels, 4×8 pixels, and 4×4 pixels shown in the lower tier, as a third hierarchical level.

By employing such a hierarchical structure, regarding a 16×16 pixel block or smaller, a greater block can be defined as a superset thereof while maintaining compatibility with the H.264/AVC format.

### 7. Seventh Embodiment

### [Personal Computer]

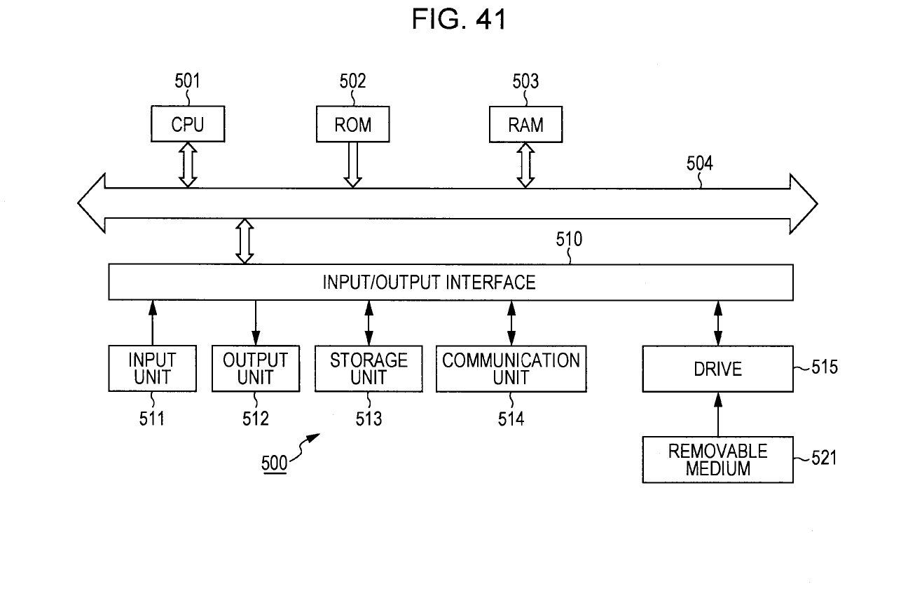

The above-described series of processing may be executed by hardware, and may be executed by software. In this case, a configuration may be made as a personal computer such as shown in FIG. 41, for example.

In FIG. 41, a CPU 501 of a personal computer 500 executes various types of processing following programs stored in ROM (Read Only Memory) 502 or programs loaded to RAM (Random Access Memory) 503 from a storage unit 513. The RAM 503 also stores data and so forth necessary for the CPU 501 to execute various types of processing, as appropriate.

The CPU 501, ROM 502, and RAM 503 are mutually connected by a bus 504. This bus 504 is also connected to an input/output interface 510.

Connected to the input/output interface 510 is an input unit 511 made up of a keyboard, a mouse, and so forth, an output unit 512 made up of a display such as a CRT (Cathode Ray Tube) or LCD (Liquid Crystal Display) or the like, a speaker, and so forth, a storage unit 513 made up of a hard disk and so forth, and a communication unit 514 made up of a modem and so forth. The communication unit 514 performs communication processing via networks including the Internet.

Also connected to the input/output interface 510 is a drive 515 as necessary, to which a removable medium 521 such as a magnetic disk, an optical disc, a magneto-optical disk, semiconductor memory, or the like, is mounted as appropriate, and computer programs read out therefrom are installed in the storage unit 513 as necessary.

In the event of executing the above-described series of processing by software, a program configuring the software is installed from a network or recording medium.

As shown in FIG. 41, for example, this recording medium is not only configured of a removable medium 521 made up of a magnetic disk (including flexible disk), optical disc (including CD-ROM (Compact Disc-Read Only Memory), DVD (Digital Versatile Disc), magneto-optical disc (including MD (Mini Disc)), or semiconductor memory or the like, in which programs are recorded and distributed so as to distribute programs to users separately from the device main unit, but also is configured of ROM 502, a hard disk included in the storage unit 513, and so forth, in which programs are recorded, distributed to users in a state of having been built into the device main unit beforehand.

Note that a program which the computer executes may be a program in which processing is performed in time sequence following the order described in the present Specification, or may be a program in which processing is performed in parallel, or at a necessary timing, such as when a call-up has been performed.

Also, with the present Specification, steps describing programs recorded in the recording medium includes processing performed in time sequence following the described order as a matter of course, and also processing executed in parallel or individually, without necessarily being processed in time sequence.

Also, with the present specification, the term system represents the entirety of devices configured of multiple devices (devices).

Also, a configuration which has been described above as one device (or processing unit) may be divided and configured as multiple devices (or processing units). Conversely, configurations which have been described above as multiple devices (or processing units) may be integrated and configured as a single device (or processing unit). Also, configurations other than those described above may be added to the configuration of the devices (or processing units), as a matter of course. Further, part of a configuration of a certain device (or processing unit) may be included in a configuration of another device (or another processing unit), as long as the configuration and operations of the overall system is substantially the same. That is to say, the embodiments of the present invention are not restricted to the above-described embodiments, and that various modifications may be made without departing from the essence of the present invention.

For example, the above-described image encoding device 100 and image decoding device 200 may be applied to various electronic devices. The following is a description of examples thereof.

### 8. Eighth Embodiment

### [Television Receiver]

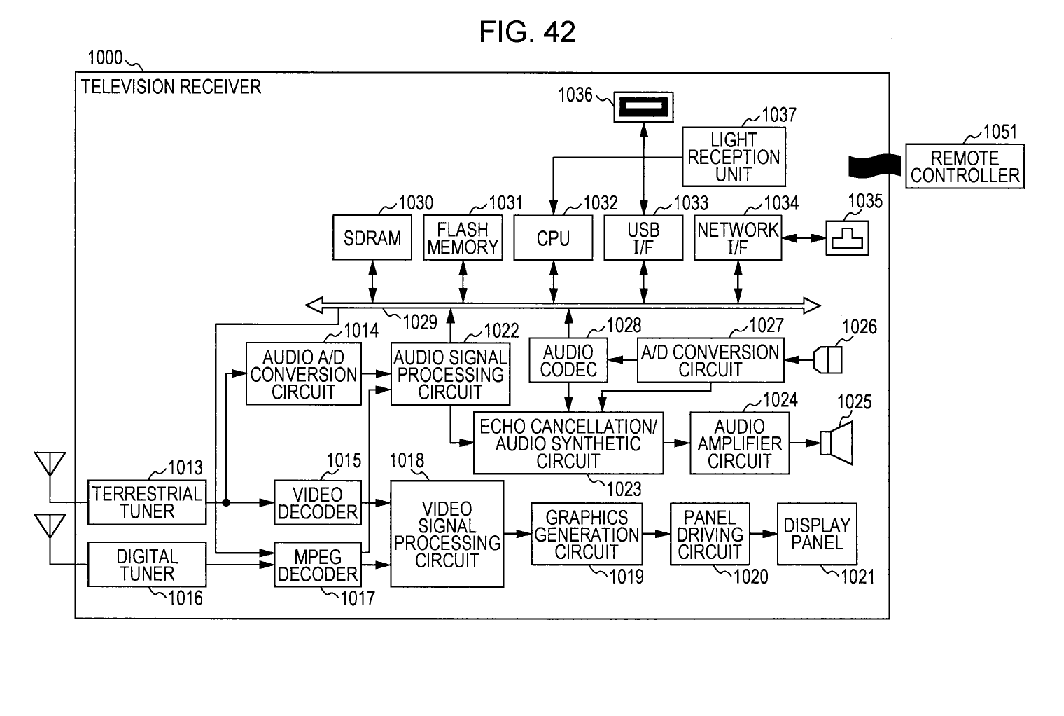

FIG. 42 is a block diagram illustrating a primary configuration example of a television receiver using the image decoding device 200 to which the present invention has been applied.

A television receiver 1000 shown in FIG. 42 includes a terrestrial tuner 1013, a video decoder 1015, a video signal processing circuit 1018, a graphics generating circuit 1019, a panel driving circuit 1020, and a display panel 1021.

The terrestrial tuner 1013 receives the broadcast wave signals of a terrestrial analog broadcast via an antenna, demodulates, obtains video signals, and supplies these to the video decoder 1015. The video decoder 1015 subjects the video signals supplied from the terrestrial tuner 1013 to decoding processing, and supplies the obtained digital component signals to the video signal processing circuit 1018.

The video signal processing circuit 1018 subjects the video data supplied from the video decoder 1015 to predetermined processing such as noise removal or the like, and supplies the obtained video data to the graphics generating circuit 1019.

The graphics generating circuit 1019 generates the video data of a program to be displayed on a display panel 1021, or image data due to processing based on an application to be supplied via a network, or the like, and supplies the generated video data or image data to the panel driving circuit 1020. Also, the graphics generating circuit 1019 also performs processing such as supplying video data obtained by generating video data (graphics) for the user displaying a screen used for selection of an item or the like, and superimposing this on the video data of a program, to the panel driving circuit 1020 as appropriate.

The panel driving circuit 1020 drives the display panel 1021 based on the data supplied from the graphics generating circuit 1019 to display the video of a program, or the above-mentioned various screens on the display panel 1021.

The display panel 1021 is made up of an LCD (Liquid Crystal Display) and so forth, and displays the video of a program or the like in accordance with the control by the panel driving circuit 1020.

Also, the television receiver 1000 also includes an audio A/D (Analog/Digital) conversion circuit 1014, an audio signal processing circuit 1022, an echo cancellation/audio synthesizing circuit 1023, an audio amplifier circuit 1024, and a speaker 1025.

The terrestrial tuner 1013 demodulates the received broadcast wave signal, thereby obtaining not only a video signal but also an audio signal. The terrestrial tuner 1013 supplies the obtained audio signal to the audio A/D conversion circuit 1014.

The audio A/D conversion circuit 1014 subjects the audio signal supplied from the terrestrial tuner 1013 to A/D conversion processing, and supplies the obtained digital audio signal to the audio signal processing circuit 1022.

The audio signal processing circuit 1022 subjects the audio data supplied from the audio A/D conversion circuit 1014 to predetermined processing such as noise removal or the like, and supplies the obtained audio data to the echo cancellation/audio synthesizing circuit 1023.

The echo cancellation/audio synthesizing circuit 1023 supplies the audio data supplied from the audio signal processing circuit 1022 to the audio amplifier circuit 1024.

The audio amplifier circuit 1024 subjects the audio data supplied from the echo cancellation/audio synthesizing circuit 1023 to D/A conversion processing, subjects to amplifier processing to adjust to predetermined volume, and then outputs the audio from the speaker 1025.

Further, the television receiver 1000 also includes a digital tuner 1016, and an MPEG decoder 1017.

The digital tuner 1016 receives the broadcast wave signals of a digital broadcast (terrestrial digital broadcast, BS (Broadcasting Satellite)/CS (Communications Satellite) digital broadcast) via the antenna, demodulates to obtain MPEG-TS (Moving Picture Experts Group-Transport Stream), and supplies this to the MPEG decoder 1017.

The MPEG decoder 1017 descrambles the scrambling given to the MPEG-TS supplied from the digital tuner 1016, and extracts a stream including the data of a program serving as a playing object (viewing object). The MPEG decoder 1017 decodes an audio packet making up the extracted stream, supplies the obtained audio data to the audio signal processing circuit 1022, and also decodes a video packet making up the stream, and supplies the obtained video data to the video signal processing circuit 1018. Also, the MPEG decoder 1017 supplies EPG (Electronic Program Guide) data extracted from the MPEG-TS to a CPU 1032 via an unshown path.

The television receiver 1000 uses the above-mentioned image decoding device 200 as the MPEG decoder 1017 for decoding video packets in this way. Note that the MPEG-TS transmitted from the broadcasting station or the like has been encoded by the image encoding device 100.

In the same way as with the image decoding device 200, the MPEG decoder 1017 generates a prediction image using plane parameters extracted from encoded data supplied from the image encoding device 100, and generates decoded image data from the residual information using the prediction image. Accordingly, the MPEG decoder 1017 can further improve encoding efficiency.

The video data supplied from the MPEG decoder 1017 is, in the same way as with the case of the video data supplied from the video decoder 1015, subjected to predetermined processing at the video signal processing circuit 1018, superimposed on the generated video data and so forth at the graphics generating circuit 1019 as appropriate, supplied to the display panel 1021 via the panel driving circuit 1020, and the image thereof is displayed thereon.

The audio data supplied from the MPEG decoder 1017 is, in the same way as with the case of the audio data supplied from the audio A/D conversion circuit 1014, subjected to predetermined processing at the audio signal processing circuit 1022, supplied to the audio amplifier circuit 1024 via the echo cancellation/audio synthesizing circuit 1023, and subjected to D/A conversion processing and amplifier processing. As a result thereof, the audio adjusted in predetermined volume is output from the speaker 1025.

Also, the television receiver 1000 also includes a microphone 1026, and an A/D conversion circuit 1027.

The A/D conversion circuit 1027 receives the user's audio signals collected by the microphone 1026 provided to the television receiver 1000 serving as for audio conversation, subjects the received audio signal to A/D conversion processing, and supplies the obtained digital audio data to the echo cancellation/audio synthesizing circuit 1023.

In the event that the user (user A)'s audio data of the television receiver 1000 has been supplied from the A/D conversion circuit 1027, the echo cancellation/audio synthesizing circuit 1023 perform echo cancellation with the user (user A)'s audio data taken as a object, and outputs audio data obtained by synthesizing the user A's audio data and other audio data, or the like from the speaker 1025 via the audio amplifier circuit 1024.

Further, the television receiver 1000 also includes an audio codec 1028, an internal bus 1029, SDRAM (Synchronous Dynamic Random Access Memory) 1030, flash memory 1031, a CPU 1032, a USB (Universal Serial Bus) I/F 1033, and a network I/F 1034.

The A/D conversion circuit 1027 receives the user's audio signal collected by the microphone 1026 provided to the television receiver 1000 serving as for audio conversation, subjects the received audio signal to A/D conversion processing, and supplies the obtained digital audio data to the audio codec 1028.

The audio codec 1028 converts the audio data supplied from the A/D conversion circuit 1027 into the data of a predetermined format for transmission via a network, and supplies to the network I/F 1034 via the internal bus 1029.

The network I/F 1034 is connected to the network via a cable mounted on a network terminal 1035. The network I/F 1034 transmits the audio data supplied from the audio codec 1028 to another device connected to the network thereof, for example. Also, the network I/F 1034 receives, via the network terminal 1035, the audio data transmitted from another device connected thereto via the network, and supplies this to the audio codec 1028 via the internal bus 1029, for example.

The audio codec 1028 converts the audio data supplied from the network I/F 1034 into the data of a predetermined format, and supplies this to the echo cancellation/audio synthesizing circuit 1023.

The echo cancellation/audio synthesizing circuit 1023 performs echo cancellation with the audio data supplied from the audio codec 1028 taken as a object, and outputs the data of audio obtained by synthesizing the audio data and other audio data, or the like, from the speaker 1025 via the audio amplifier circuit 1024.

The SDRAM 1030 stores various types of data necessary for the CPU 1032 performing processing.

The flash memory 1031 stores a program to be executed by the CPU 1032. The program stored in the flash memory 1031 is read out by the CPU 1032 at predetermined timing such as when activating the television receiver 1000, or the like. EPG data obtained via a digital broadcast, data obtained from a predetermined server via the network, and so forth are also stored in the flash memory 1031.

For example, MPEG-TS including the content data obtained from a predetermined server via the network by the control of the CPU 1032 is stored in the flash memory 1031. The flash memory 1031 supplies the MPEG-TS thereof to the MPEG decoder 1017 via the internal bus 1029 by the control of the CPU 1032, for example.

The MPEG decoder 1017 processes the MPEG-TS thereof in the same way as with the case of the MPEG-TS supplied from the digital tuner 1016. In this way, the television receiver 1000 receives the content data made up of video, audio, and so forth via the network, decodes using the MPEG decoder 1017, whereby video thereof can be displayed, and audio thereof can be output.

Also, the television receiver 1000 also includes a light reception unit 1037 for receiving the infrared signal transmitted from a remote controller 1051.

The light reception unit 1037 receives infrared rays from the remote controller 1051, and outputs a control code representing the content of the user's operation obtained by demodulation, to the CPU 1032.

The CPU 1032 executes the program stored in the flash memory 1031 to control the entire operation of the television receiver 1000 according to the control code supplied from the light reception unit 1037, and so forth. The CPU 1032, and the units of the television receiver 1000 are connected via an unshown path.

The USB I/F 1033 performs transmission/reception of data as to an external device of the television receiver 1000 which is connected via a USB cable mounted on a USB terminal 1036. The network I/F 1034 connects to the network via a cable mounted on the network terminal 1035, also performs transmission/reception of data other than audio data as to various devices connected to the network.

The television receiver 1000 can further improve encoding efficiency by using the image decoding device 200 as the MPEG decoder 1017. As a result, the television receiver 1000 can further improve encoding efficiency of broadcast signals received via an antenna or content data obtained via a network, and can realize real-time processing with lower costs.

### 9. Ninth Embodiment

### [Cellular Telephone]

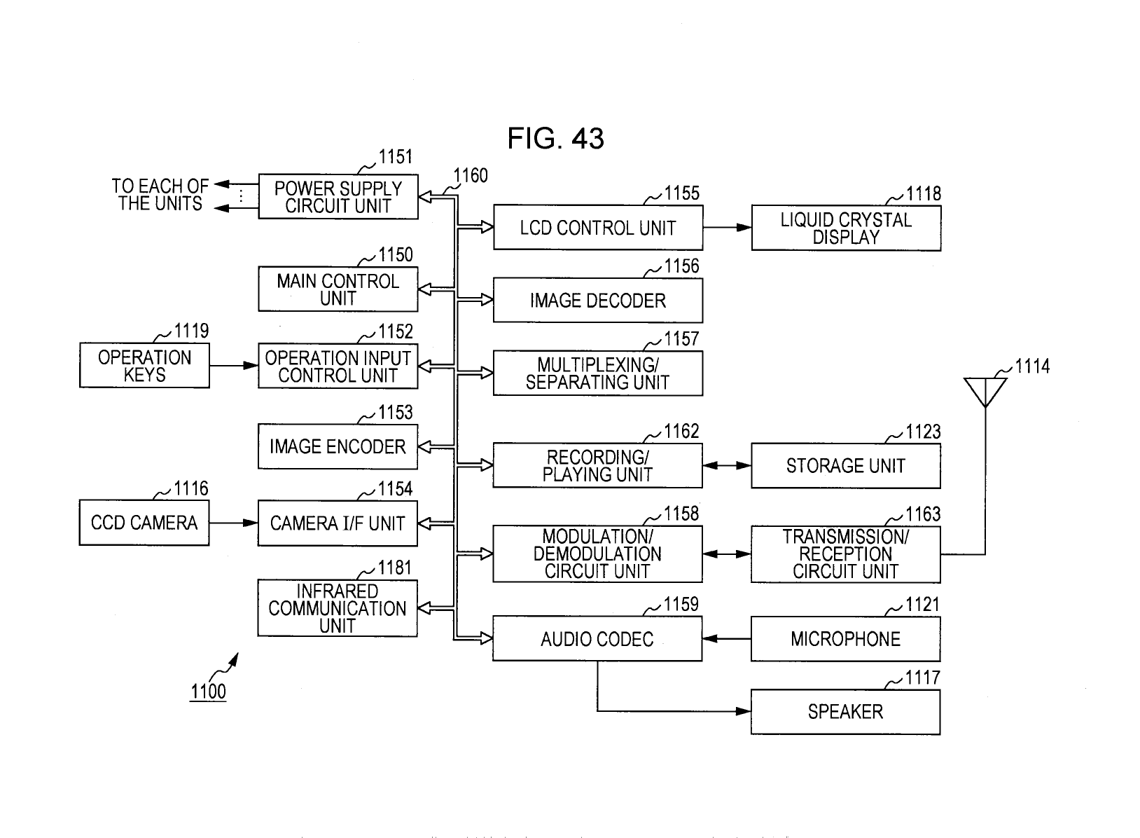

FIG. 43 is a block diagram illustrating a primary configuration example of a cellular telephone using the image encoding device 100 and image decoding device 200 to which the present invention has been applied.

A cellular telephone 1100 shown in FIG. 43 includes a main control unit 1150 configured so as to integrally control the units, a power supply circuit unit 1151, an operation input control unit 1152, an image encoder 1153, a camera I/F unit 1154, an LCD control unit 1155, an image decoder 1156, a multiplexing/separating unit 1157, a recording/playing unit 1162, a modulation/demodulation circuit unit 1158, and an audio codec 1159. These are mutually connected via a bus 1160.

Also, the cellular telephone 1100 includes operation keys 1119, a CCD (Charge Coupled Devices) camera 1116, a liquid crystal display 1118, a storage unit 1123, a transmission/reception circuit unit 1163, an antenna 1114, a microphone (MIC) 1121, and a speaker 1117.

Upon a call end and power key being turned on by the user's operation, the power supply circuit unit 1151 activates the cellular telephone 1100 in an operational state by supplying power to the units from a battery pack.

The cellular telephone 1100 performs various operations, such as transmission/reception of an audio signal, transmission/reception of an e-mail and image data, image shooting, data recoding, and so forth, in various modes such as a voice call mode, a data communication mode, and so forth, based on the control of the main control unit 1150 made up of a CPU, ROM, RAM, and so forth.

For example, in the voice call mode, the cellular telephone 1100 converts the audio signal collected by the microphone (mike) 1121 into digital audio data by the audio codec 1159, subjects this to spectrum spread processing at the modulation/demodulation circuit unit 1158, and subjects this to digital/analog conversion processing and frequency conversion processing at the transmission/reception circuit unit 1163. The cellular telephone 1100 transmits the signal for transmission obtained by the conversion processing thereof to an unshown base station via the antenna 1114. The signal for transmission (audio signal) transmitted to the base station is supplied to the cellular telephone of the other party via the public telephone network.

Also, for example, in the voice call mode, the cellular telephone 1100 amplifies the reception signal received at the antenna 1114, at the transmission/reception circuit unit 1163, further subjects to frequency conversion processing and analog/digital conversion processing, subjects to spectrum inverse spread processing at the modulation/demodulation circuit unit 1158, and converts into an analog audio signal by the audio codec 1159. The cellular telephone 1100 outputs the converted and obtained analog audio signal thereof from the speaker 1117.

Further, for example, in the event of transmitting an e-mail in the data communication mode, the cellular telephone 1100 accepts the text data of the e-mail input by the operation of the operation keys 1119 at the operation input control unit 1152. The cellular telephone 1100 processes the text data thereof at the main control unit 1150, and displays on the liquid crystal display 1118 via the LCD control unit 1155 as an image.

Also, the cellular telephone 1100 generates e-mail data at the main control unit 1150 based on the text data accepted by the operation input control unit 1152, the user's instructions, and so forth. The cellular telephone 1100 subjects the e-mail data thereof to spectrum spread processing at the modulation/demodulation circuit unit 1158, and subjects to digital/analog conversion processing and frequency conversion processing at the transmission/reception circuit unit 1163. The cellular telephone 1100 transmits the signal for transmission obtained by the conversion processing thereof to an unshown base station via the antenna 1114. The signal for transmission (e-mail) transmitted to the base station is supplied to a predetermined destination via the network, mail server, and so forth.

Also, for example, in the event of receiving an e-mail in the data communication mode, the cellular telephone 1100 receives the signal transmitted from the base station via the antenna 1114 with the transmission/reception circuit unit 1163, amplifies, and further subjects to frequency conversion processing and analog/digital conversion processing. The cellular telephone 1100 subjects the reception signal thereof to spectrum inverse spread processing at the modulation/demodulation circuit unit 1158 to restore the original e-mail data. The cellular telephone 1100 displays the restored e-mail data on the liquid crystal display 1118 via the LCD control unit 1155.

Note that the cellular telephone 1100 may record (store) the received e-mail data in the storage unit 1123 via the recording/playing unit 1162.

This storage unit 1123 is an optional rewritable recording medium. The storage unit 1123 may be, for example, semiconductor memory such as RAM, built-in flash memory, or the like, may be a hard disk, or may be a removable medium such as a magnetic disk, a magneto-optical disk, an optical disc, USB memory, a memory card, or the like. It goes without saying that the storage unit 1123 may be other than these.

Further, for example, in the event of transmitting image data in the data communication mode, the cellular telephone 1100 generates image data by imaging at the CCD camera 1116. The CCD camera 1116 includes a CCD serving as an optical device such as a lens, diaphragm, and so forth, and serving as a photoelectric conversion device, which images a subject, converts the intensity of received light into an electrical signal, and generates the image data of an image of the subject. The CCD camera 1116 performs compression encoding of the image data at the image encoder 1153 via the camera I/F unit 1154, and converts into encoded image data.

The cellular telephone 1100 employs the above-mentioned image encoding device 100 as the image encoder 1153 for performing such processing. Accordingly, in the same way as with the image encoding device 100, the image encoder 1053 performs plane approximation using pixel values of the block to be processed itself of the original image, and generates a prediction image. By encoding image data using such a prediction image, the image encoder 1053 can further improve encoding efficiency.

Note that, at this time simultaneously, the cellular telephone 1100 converts the audio collected at the microphone (mike) 1121, while shooting with the CCD camera 1116, from analog to digital at the audio codec 1159, and further encodes this.

The cellular telephone 1100 multiplexes the encoded image data supplied from the image encoder 1153, and the digital audio data supplied from the audio codec 1159 at the multiplexing/separating unit 1157 using a predetermined method. The cellular telephone 1100 subjects the multiplexed data obtained as a result thereof to spectrum spread processing at the modulation/demodulation circuit unit 1158, and subjects to digital/analog conversion processing and frequency conversion processing at the transmission/reception circuit unit 1163. The cellular telephone 1100 transmits the signal for transmission obtained by the conversion processing thereof to an unshown base station via the antenna 1114. The signal for transmission (image data) transmitted to the base station is supplied to the other party via the network or the like.

Note that in the event that image data is not transmitted, the cellular telephone 1100 may also display the image data generated at the CCD camera 1116 on the liquid crystal display 1118 via the LCD control unit 1155 instead of the image encoder 1153.

Also, for example, in the event of receiving the data of a moving image file linked to a simple website or the like in the data communication mode, the cellular telephone 1100 receives the signal transmitted from the base station at the transmission/reception circuit unit 1163 via the antenna 1114, amplifies, and further subjects to frequency conversion processing and analog/digital conversion processing. The cellular telephone 1100 subjects the received signal to spectrum inverse spread processing at the modulation/demodulation circuit unit 1158 to restore the original multiplexed data. The cellular telephone 1100 separates the multiplexed data thereof at the multiplexing/separating unit 1157 into encoded image data and audio data.

The cellular telephone 1100 decodes the encoded image data at the image decoder 1156, thereby generating playing moving image data, and displays this on the liquid crystal display 1118 via the LCD control unit 1155. Thus, moving image data included in a moving image file linked to a simple website is displayed on the liquid crystal display 1118, for example.

The cellular telephone 1100 employs the above-mentioned image decoding device 200 as the image decoder 1156 for performing such processing. Accordingly, in the same way as with the image decoding device 200, the image decoder 1156 generates a prediction image using plane parameters extracted from the encoded data supplied from the image encoding device 100, and generates decoded image data from the residual information using the prediction image. Accordingly, the image decoder 1156 can further improve encoding efficiency.

At this time, simultaneously, the cellular telephone 1100 converts the digital audio data into an analog audio signal at the audio codec 1159, and outputs this from the speaker 1117. Thus, audio data included in a moving image file linked to a simple website is played, for example.

Note that, in the same way as with the case of e-mail, the cellular telephone 1100 may record (store) the received data linked to a simple website or the like in the storage unit 1123 via the recording/playing unit 1162.

Also, the cellular telephone 1100 analyzes the imaged two-dimensional code obtained by the CCD camera 1116 at the main control unit 1150, whereby information recorded in the two-dimensional code can be obtained.

Further, the cellular telephone 1100 can communicate with an external device at the infrared communication unit 1181 using infrared rays.

The cellular telephone 1100 employs the image encoding device 100 as the image encoder 1153, whereby encoding efficiency at the time of encoding and transmitting data generated by encoding image data generated at the CCD camera 1116, for example, thereby realizing real-time processing at lower costs.

Also, the cellular telephone 1100 employs the image decoding device 200 as the image decoder 1156, and thus can further improve the encoding efficiency of data (encoded data) of a moving image file linked to at a simple website or the like, for example.

Note that description has been made so far wherein the cellular telephone 1100 employs the CCD camera 1116, but the cellular telephone 1100 may employ an image sensor (CMOS image sensor) using CMOS (Complementary Metal Oxide Semiconductor) instead of this CCD camera 1116. In this case as well, the cellular telephone 1100 can image a subject and generate the image data of an image of the subject in the same way as with the case of employing the CCD camera 1116.

Also, description has been made so far regarding the cellular telephone 1100, but the image encoding device 100 and the image decoding device 200 may be applied to any kind of device in the same way as with the case of the cellular telephone 1100 as long as it is a device having the same imaging function and communication function as those of the cellular telephone 1100, for example, such as a PDA (Personal Digital Assistants), smart phone, UMPC (Ultra Mobile Personal Computer), net book, notebook-sized personal computer, or the like.

### 10. Tenth Embodiment

### [Hard Disk Recorder]

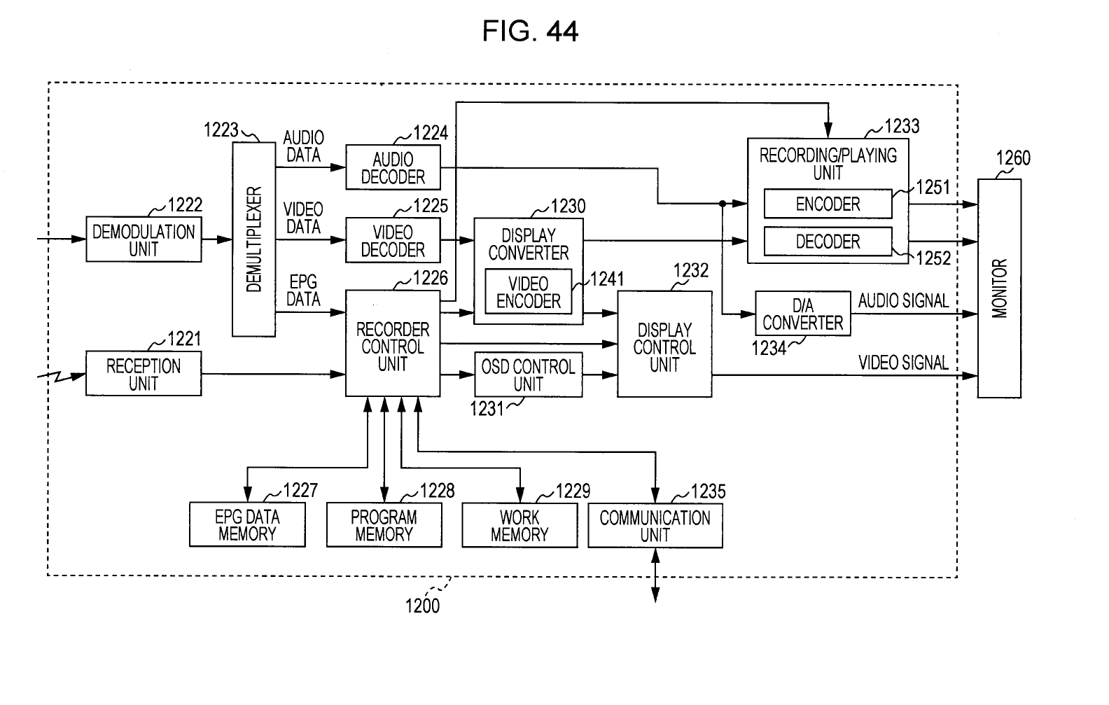

FIG. 44 is a block diagram illustrating a primary configuration example of a hard disk recorder which employs the image encoding device 100 and image decoding device 200 to which the present invention has been applied.

A hard disk recorder (HDD recorder) 1200 shown in FIG. 44 is a device which stores, in a built-in hard disk, audio data and video data of a broadcast program included in broadcast wave signals (television signals) received by a tuner and transmitted from a satellite or a terrestrial antenna or the like, and provides the stored data to the user at timing according to the user's instructions.

The hard disk recorder 1200 can extract audio data and video data from broadcast wave signals, decode these as appropriate, and store in the built-in hard disk, for example. Also, the hard disk recorder 1200 can also obtain audio data and video data from another device via the network, decode these as appropriate, and store in the built-in hard disk, for example.

Further, the hard disk recorder 1200 can decode audio data and video data recorded in the built-in hard disk, supply this to a monitor 1260, display an image thereof on the screen of the monitor 1260, and output audio thereof from the speaker of the monitor 1260, for example. Also, the hard disk recorder 1200 can decode audio data and video data extracted from broadcast signals obtained via a tuner, or audio data and video data obtained from another device via a network, supply this to the monitor 1260, display an image thereof on the screen of the monitor 1260, and output audio thereof from the speaker of the monitor 1260, for example.

Of course, operations other than these may be performed.

As shown in FIG. 44, the hard disk recorder 1200 includes a reception unit 1221, a demodulation unit 1222, a demultiplexer 1223, an audio decoder 1224, a video decoder 1225, and a recorder control unit 1226. The hard disk recorder 1200 further includes EPG data memory 1227, program memory 1228, work memory 1229, a display converter 1230, an OSD (On Screen Display) control unit 1231, a display control unit 1232, a recording/playing unit 1233, a D/A converter 1234, and a communication unit 1235.

Also, the display converter 1230 includes a video encoder 1241. The recording/playing unit 1233 includes an encoder 1251 and a decoder 1252.

The reception unit 1221 receives the infrared signal from the remote controller (not shown), converts into an electrical signal, and outputs to the recorder control unit 1226. The recorder control unit 1226 is configured of, for example, a microprocessor and so forth, and executes various types of processing in accordance with the program stored in the program memory 1228. At this time, the recorder control unit 1226 uses the work memory 1229 according to need.

The communication unit 1235, which is connected to the network, performs communication processing with another device via the network. For example, the communication unit 1235 is controlled by the recorder control unit 1226 to communicate with a tuner (not shown), and to principally output a channel selection control signal to the tuner.

The demodulation unit 1222 demodulates the signal supplied from the tuner, and outputs to the demultiplexer 1223. The demultiplexer 1223 separates the data supplied from the demodulation unit 1222 into audio data, video data, and EPG data, and outputs to the audio decoder 1224, video decoder 1225, and recorder control unit 1226, respectively.

The audio decoder 1224 decodes the input audio data, and outputs to the recording/playing unit 1233. The video decoder 1225 decodes the input video data, and outputs to the display converter 1230. The recorder control unit 1226 supplies the input EPG data to the EPG data memory 1227 for storing.

The display converter 1230 encodes the video data supplied from the video decoder 1225 or recorder control unit 1226 into, for example, the video data conforming to the NTSC (National Television Standards Committee) format using the video encoder 1241, and outputs to the recording/playing unit 1233. Also, the display converter 1230 converts the size of the screen of the video data supplied from the video decoder 1225 or recorder control unit 1226 into the size corresponding to the size of the monitor 1260, converts into the video data conforming to the NTSC format using the video encoder 1241, converts into an analog signal, and outputs to the display control unit 1232.

The display control unit 1232 superimposes, under the control of the recorder control unit 1226, the OSD signal output from the OSD (On Screen Display) control unit 1231 on the video signal input from the display converter 1230, and outputs to the display of the monitor 1260 for display.

Also, the audio data output from the audio decoder 1224 has been converted into an analog signal using the D/A converter 1234, and supplied to the monitor 1260. The monitor 1260 outputs this audio signal from a built-in speaker.

The recording/playing unit 1233 includes a hard disk as a recording medium in which video data, audio data, and so forth are recorded.

The recording/playing unit 1233 encodes the audio data supplied from the audio decoder 1224 by the encoder 1251, for example. Also, the recording/playing unit 1233 encodes the video data supplied from the video encoder 1241 of the display converter 1230 by the encoder 1251. The recording/playing unit 1233 synthesizes the encoded data of the audio data thereof, and the encoded data of the video data thereof using the multiplexer. The recording/playing unit 1233 amplifies the synthesized data by channel coding, and writes the data thereof in the hard disk via a recording head.

The recording/playing unit 1233 plays the data recorded in the hard disk via a playing head, amplifies, and separates into audio data and video data using the demultiplexer. The recording/playing unit 1233 decodes the audio data and video data by the decoder 1252. The recording/playing unit 1233 converts the decoded audio data from digital to analog, and outputs to the speaker of the monitor 1260. Also, the recording/playing unit 1233 converts the decoded video data from digital to analog, and outputs to the display of the monitor 1260.

The recorder control unit 1226 reads out the latest EPG data from the EPG data memory 1227 based on the user's instructions indicated by the infrared signal from the remote controller which is received via the reception unit 1221, and supplies this to the OSD control unit 1231. The OSD control unit 1231 generates image data corresponding to the input EPG data, and outputs to the display control unit 1232. The display control unit 1232 outputs the video data input from the OSD control unit 1231 to the display of the monitor 1260 for display. Thus, EPG (Electronic Program Guide) is displayed on the display of the monitor 1260.

Also, the hard disk recorder 1200 can obtain various types of data such as video data, audio data, EPG data, and so forth supplied from another device via the network such as the Internet or the like.

The communication unit 1235 is controlled by the recorder control unit 1226 to obtain encoded data such as video data, audio data, EPG data, and so forth transmitted from another device via the network, and to supply this to the recorder control unit 1226. The recorder control unit 1226 supplies the encoded data of the obtained video data and audio data to the recording/playing unit 1233, and stores in the hard disk, for example. At this time, the recorder control unit 1226 and recording/playing unit 1233 may perform processing such as re-encoding or the like according to need.

Also, the recorder control unit 1226 decodes the encoded data of the obtained video data and audio data, and supplies the obtained video data to the display converter 1230. The display converter 1230 processes, in the same way as the video data supplied from the video decoder 1225, the video data supplied from the recorder control unit 1226, supplies to the monitor 1260 via the display control unit 1232 for displaying an image thereof.

Alternatively, an arrangement may be made wherein in accordance with this image display, the recorder control unit 1226 supplies the decoded audio data to the monitor 1260 via the D/A converter 1234, and outputs audio thereof from the speaker.

Further, the recorder control unit 1226 decodes the encoded data of the obtained EPG data, and supplies the decoded EPG data to the EPG data memory 1227.

The hard disk recorder 1200 thus configured employs the image decoding device 200 as the video decoder 1225, decoder 1252, and decoder housed in the recorder control unit 1226. Accordingly, in the same way as with the image decoding device 200, the video decoder 1225, decoder 1252, and decoder housed in the recorder control unit 1226 generate a prediction image using the plane parameters extracted from encoded image data supplied from the image encoding device 100, and generates decoded image data from the residual information using the prediction image. Accordingly, the video decoder 1225, decoder 1252, and decoder housed in the recorder control unit 1226 can further improve encoding efficiency.

Accordingly, the hard disk recorder 1200 can further improve encoding efficiency of video data which the tuner or communication unit 1235 receives (encoded data) and video data which the recording/playing unit 1233 plays (encoded data) for example, thereby realizing real-time processing with lower costs.

Also, the hard disk recorder 1200 employs the image encoding device 100 as the encoder 1251. Accordingly, in the same way as with the case of the image encoding device 100, the encoder 1251 performs plane approximation using pixel values of the block to be processed itself of the original image, and generates a prediction image. Accordingly, the encoder 1251 can further improve encoding efficiency.

Accordingly, the hard disk recorder 1200 can further improve encoding efficiency of encoded data recorded in the hard disk, thereby realizing real-time processing with lower costs.

Note that description has been made so far regarding the hard disk recorder 1200 for recording video data and audio data in the hard disk, but it goes without saying that any kind of recording medium may be employed. For example, even with a recorder to which a recording medium other than a hard disk, such as flash memory, optical disc, video tape, or the like, is applied, the image encoding device 100 and image decoding device 200 can be applied thereto in the same way as with the case of the above hard disk recorder 1200.

### 11. Eleventh Embodiment

### [Camera]

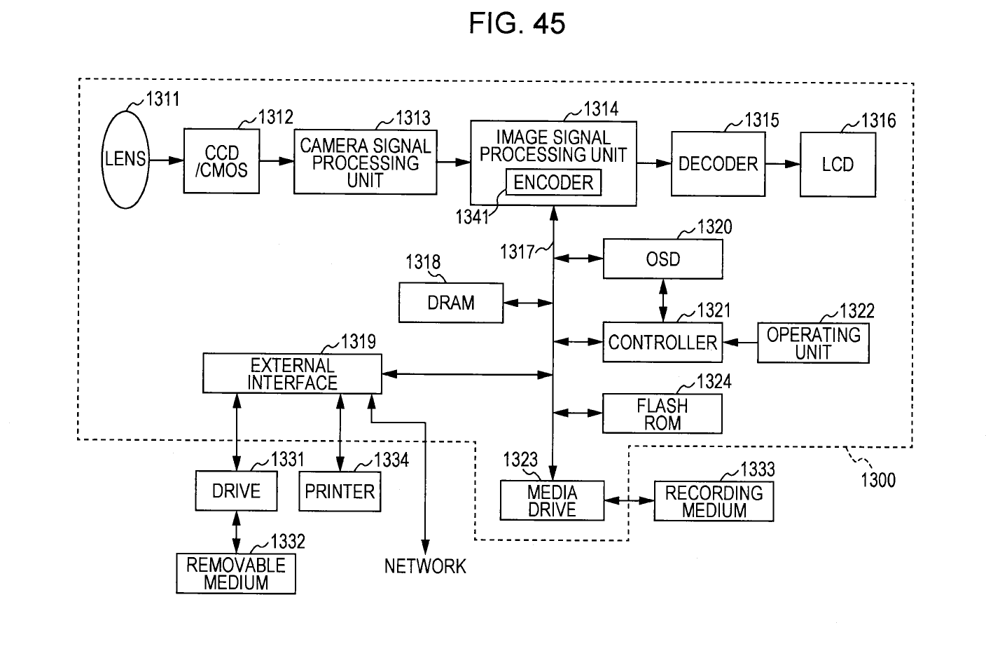

FIG. 45 is a block diagram illustrating a primary configuration example of a camera employing the image encoding device 100 and image decoding device 200 to which the present invention has been applied.

A camera 1300 shown in FIG. 45 images a subject, displays an image of the subject on an LCD 1316, and records this in a recording medium 1333 as image data.

A lens block 1311 inputs light (i.e., picture of a subject) to a CCD/CMOS 2012. The CCD/CMOS 2012 is an image sensor employing a CCD or CMOS, which converts the intensity of received light into an electrical signal, and supplies to a camera signal processing unit 1313.

The camera signal processing unit 1313 converts the electrical signal supplied from the CCD/CMOS 2012 into color difference signals of Y, Cr, and Cb, and supplies to an image signal processing unit 1314. The image signal processing unit 1314 subjects, under the control of a controller 1321, the image signal supplied from the camera signal processing unit 1313 to predetermined image processing, or encodes the image signal thereof by an encoder 1341. The image signal processing unit 1314 supplies encoded data generated by encoding an image signal, to a decoder 1315. Further, the image signal processing unit 1314 obtains data for display generated at an on-screen display (OSD) 1320, and supplies this to the decoder 1315.

With the above-mentioned processing, the camera signal processing unit 1313 appropriately takes advantage of DRAM (Dynamic Random Access Memory) 1318 connected via a bus 1317 to hold image data, encoded data encoded from the image data thereof, and so forth in the DRAM 1318 thereof according to need.

The decoder 1315 decodes the encoded data supplied from the image signal processing unit 1314, and supplies obtained image data (decoded image data) to the LCD 1316. Also, the decoder 1315 supplies the data for display supplied from the image signal processing unit 1314 to the LCD 1316. The LCD 1316 synthesizes the image of the decoded image data, and the image of the data for display, supplied from the decoder 1315 as appropriate, and displays a synthesizing image thereof.

The on-screen display 1320 outputs, under the control of the controller 1321, data for display such as a menu screen or icon or the like made up of a symbol, characters, or a figure to the image signal processing unit 1314 via the bus 1317.

Based on a signal indicating the content commanded by the user using an operating unit 1322, the controller 1321 executes various types of processing, and also controls the image signal processing unit 1314, DRAM 1318, external interface 1319, on-screen display 1320, media drive 1323, and so forth via the bus 1317. Programs, data, and so forth necessary for the controller 1321 executing various types of processing are stored in FLASH ROM 1324.

For example, the controller 1321 can encode image data stored in the DRAM 1318, or decode encoded data stored in the DRAM 1318 instead of the image signal processing unit 1314 and decoder 1315. At this time, the controller 1321 may perform encoding and decoding processing using the same format as the encoding and decoding format of the image signal processing unit 1314 and decoder 1315, or may perform encoding/decoding processing using a format that neither the image signal processing unit 1314 nor the decoder 1315 can handle.

Also, for example, in the event that start of image printing has been instructed from the operating unit 1322, the controller 1321 reads out image data from the DRAM 1318, and supplies this to a printer 1334 connected to the external interface 1319 via the bus 1317 for printing.

Further, for example, in the event that image recording has been instructed from the operating unit 1322, the controller 1321 reads out encoded data from the DRAM 1318, and supplies this to a recording medium 1333 mounted on the media drive 1323 via the bus 1317 for storing.

The recording medium 1333 is an optional readable/writable removable medium, for example, such as a magnetic disk, a magneto-optical disk, an optical disc, semiconductor memory, or the like. It goes without saying that the recording medium 1333 is also optional regarding the type of a removable medium, and accordingly may be a tape device, or may be a disc, or may be a memory card. It goes without saying that the recoding medium 1333 may be a non-contact IC card or the like.

Alternatively, the media drive 1323 and the recording medium 1333 may be configured so as to be integrated into a non-transportable recording medium, for example, such as a built-in hard disk drive, SSD (Solid State Drive), or the like.

The external interface 1319 is configured of, for example, a USB input/output terminal and so forth, and is connected to the printer 1334 in the event of performing printing of an image. Also, a drive 1331 is connected to the external interface 1319 according to need, on which the removable medium 1332 such as a magnetic disk, optical disc, or magneto-optical disk is mounted as appropriate, and a computer program read out therefrom is installed in the FLASH ROM 1324 according to need.

Further, the external interface 1319 includes a network interface to be connected to a predetermined network such as a LAN, the Internet, or the like. For example, in accordance with the instructions from the operating unit 1322, the controller 1321 can read out encoded data from the DRAM 1318, and supply this from the external interface 1319 to another device connected via the network. Also, the controller 1321 can obtain, via the external interface 1319, encoded data or image data supplied from another device via the network, and hold this in the DRAM 1318, or supply this to the image signal processing unit 1314.

The camera 1300 thus configured employs the image decoding device 200 as the decoder 1315. Accordingly, in the same way as with the image decoding device 200, the decoder 1315 generates a prediction image using the plane parameters extracted from encoded image data supplied from the image encoding device 100, and generates decoded image data from the residual information using the prediction. Accordingly, the decoder 1315 can further improve encoding efficiency.

Accordingly, the camera 1300 can further improve encoding efficiency of image data generated at the CCD/CMOS 1312, encoded data of video data read out from the DRAM 1318 or recording medium 1333, and encoded data of video data obtained via a network for example, thereby realizing real-time processing with lower costs.

Also, the camera 1300 employs the image encoding device 100 as the encoder 1341. Accordingly, in the same way as with the case of the image encoding device 100, the encoder 1341 performs plane approximation using pixel values of the block to be processed itself of the original image, and generates a prediction image. Accordingly, the encoder 1341 can further improve encoding efficiency.

Accordingly, the camera 1300 further improve encoding efficiency of encoded data recorded in the DRAM 1318 or recording medium 1333 and encoded data provided to other devices for example, thereby realizing real-time processing with lower costs.

Note that the decoding method of the image decoding device 200 may be applied to the decoding processing which the controller 1321 performs. In the same way, the encoding method of the image encoding device 100 may be applied to the encoding processing which the controller 1321 performs.

Also, the image data which the camera 1300 takes may be moving images or may be still images.

As a matter of course, the image encoding device 100 and image decoding device 200 may be applied to devices or systems other than the above-described devices.

### REFERENCE SIGNS LIST

100 image encoding device
114 intra prediction unit
132 plane prediction image generating unit
151 plane approximation unit
152 plane generating unit
153 prediction encoding unit
154 entropy encoding unit
171 storage unit
172 neighboring block parameter obtaining unit
173 prediction computing unit
174 encoding unit
200 image decoding device
211 intra prediction unit
221 intra prediction mode determining unit
223 entropy decoding unit
224 prediction decoding unit
225 plane generating unit
231 neighboring block parameter obtaining unit
232 prediction computing unit
233 decoding unit
234 storage unit
301 plane mode parameter obtaining unit
302 encoding unit
321 plane mode plane parameter generating unit
363 transform unit
371 2×2 block forming unit
372 orthogonal transform unit
384 inverse transform unit
391 inverse orthogonal transform unit
392 plane parameter extracting unit

1-16. (canceled)

17. An image processing device comprising:
plane approximating means which, with regard to a block to be processed of image data to which intra-screen encoding is to be performed, approximates the pixel values using a function indicating a plane, and obtains plane parameters which are coefficients of said function indicating the plane using the pixel values of said block to be processed;
plane generating means which generates said plane on said block to be processed as a prediction image, by obtaining pixel values on the plane represented by said plane parameters obtained by said plane approximating means;
computing means which subtracts, from pixel values of said block to be processed, pixel values of said plane generated by said plane generating means as said prediction image, thereby generating difference data; and
encoding means which encodes said difference data generated by said computing means;
prediction encoding means which takes, as prediction values of said plane parameters, the plane parameters of an approximated plane of the block to be processed calculated in a plane mode of intra prediction modes, and subtract, from said plane parameters obtained by said plane approximating means, said prediction values; and
transmitting means which transmits said plane parameters subtracted by said plane approximating means.

18. The image processing device according to claim 17, further comprising:
orthogonal transform means which performs orthogonal transform of said difference data generated by said computing means; and
quantizing means which quantizes coefficient data generated by said difference data being subjected to orthogonal transform by said orthogonal transform means;
wherein said encoding means encodes said coefficient data quantized by said quantizing means.

19. The image processing device according to claim 17, wherein said plane approximating means obtains said plane parameters by solving smallest squares using pixel values of said block to be processed.

20. The image processing device according to claim 17, wherein said prediction encoding means predicts said plane parameters of said block to be processed, using plane parameters of a neighboring block of said block to be processed.

21. The image processing device according to claim 17, further comprising:
plane parameter orthogonal transform means which performs orthogonal transform of said plane parameters obtained by said plane approximation means; and
plane parameter encoding means which encodes said plane parameters subjected to orthogonal transform by said orthogonal transform means.

22. An image processing method of an image processing device, said method comprising:
plane approximating, with regard to a block to be processed of image data to which intra-screen encoding is to be performed, the pixel values using a function indicating a plane, and obtaining plane parameters which are coefficients of said function indicating the plane using the pixel values of said block to be processed;
plane generating said plane on said block to be processed as a prediction image, by obtaining pixel values on the plane represented by said obtained plane parameters;
subtracting, from pixel values of said block to be processed, pixel values of said plane generated as said prediction image, thereby generating difference data; and
encoding said generated difference data;
prediction encoding, as prediction values of said plane parameters, the plane parameters of an approximated plane of the block to be processed calculated in a plane mode of intra prediction modes, and subtracting, from said obtained plane parameters, said prediction values; and
transmitting said subtracted plane parameters.

23. An image processing device comprising:
accepting means which accepts encoded data, in which difference data between image data and a prediction image intra-predicted using said image data itself has been encoded, and further accepts difference values, between plane parameters made up of coefficients of a function indicating a plane approximating the pixel values of a block to be processed of said image data, and prediction values made up of plane parameters of an approximated plane of the block to be processed calculated in a plane mode of intra prediction modes;
decoding means which decodes said encoded data accepted by said accepting means;
prediction decoding means which performs prediction decoding of said plane parameters, by calculating said prediction values, and adding to said difference values accepted by said accepting means;
plane generating means which generates said prediction image, using said plane parameters subjected to prediction decoding by said prediction decoding means; and
computing means which adds said prediction image generated by said plane generating means to said difference data obtained by being decoded by said decoding means.

24. The image processing device according to claim 23, further comprising:
inverse quantizing means which performs inverse quantizing of said difference data; and
inverse orthogonal transform means which performs inverse orthogonal transform of said difference data subjected to inverse quantizing by said inverse quantizing means;
wherein said computing means adds said prediction image to said difference data subjected to inverse orthogonal transform by said inverse orthogonal transform means.

25. The image processing device according to claim 23, wherein said prediction decoding means calculates said prediction values using plane parameters of a neighboring block of said block to be processed.

26. The image processing device according to claim 23, further comprising:
plane parameter inverse transform means which performs inverse orthogonal transform of said plane parameters subjected to orthogonal transform;
wherein said plane generating means generates said prediction image using said plane parameters subjected to inverse orthogonal transform by said inverse orthogonal transform means.

27. An image processing method of an image processing device, said method comprising:
accepting encoded data, in which difference data between image data and a prediction image intra-predicted using said image data itself has been encoded, and further accepting difference values, between plane parameters made up of coefficients of a function indicating a plane approximating the pixel values of a block to be processed of said image data, and prediction values made up of plane parameters of an approximated plane of the block to be processed calculated in a plane mode of intra prediction modes;
decoding said accepted encoded data;
performing prediction decoding of said plane parameters, by calculating said prediction values, and adding to said accepted difference values;
plane generating said prediction image, using said plane parameters subjected to prediction decoding; and
adding said generated prediction image to said difference data obtained by being decoded.
